(19) United States
(12) Patent Application Publication
(10) Pub. No.: US 2026/0300675 A1
(43) Pub. Date: Oct. 1, 2026

(54) AGENT OBSERVABILITY LAYER

(71) Applicant: Amazon Technologies, Inc., Seattle, WA (US)

(72) Inventors: Etsuko Tsuzuki, New York, NY (US); Monica Lakshmi Sunkara, San Francisco, CA (US); Yi Zhang, Sammamish, WA (US); Yassine Benajiba, Briarcliff Manor, NY (US)

(21) Appl. No.: 19/094,029

(22) Filed: Mar. 28, 2025

(51) Int. Cl. G06N 3/006

(52) U.S. Cl. CPC G06N 3/006

(57) ABSTRACT

Disclosed are systems and methods that include an observability layer that observes requests and responses into and out of one or more artificial intelligence (“AI”) agents of an agentic network. As part of the observation, the observability layer determines if a received request/response is inaccurate. If an agent request is inaccurate, the observability layer prohibits an endpoint from receiving the agent request and sends a message to the AI agent that conforms to a schema of endpoint, such that the message appears to be sent by the endpoint. If an endpoint response is inaccurate, the observability layer prohibits the AI agent from receiving the endpoint response and sends a message to the AI agent that conforms to a schema of the endpoint, such that the message appears to be sent by the endpoint. By generating and sending messages that conform to an expected schema, the observability layer remains hidden.

### BACKGROUND

Machine learning (“ML”) models represent a subset of artificial intelligence (“AI”) technologies designed to learn patterns from data and make predictions or classifications based on that learning. Neural networks, a prominent type of ML model, are computational structures inspired by biological neural systems that excel at pattern recognition through layers of interconnected nodes. Traditionally, these ML models have been primarily discriminative in nature—trained to distinguish between categories or predict specific outputs based on input data. While powerful for classification, regression, and pattern recognition tasks, conventional ML models are generally limited to the specific functions they were trained to perform.

In contrast, generative AI systems represent a significant advancement beyond traditional ML models. These systems, including Large Language Models (“LLMs”), are designed not merely to classify or predict, but to generate content that resembles human-created output. Generative AI systems incorporate additional capabilities beyond ML models that enable them to understand context, maintain coherence across longer outputs, and produce creative content rather than simply identifying patterns or predicting specific outputs. This distinction marks an important evolution from reactive pattern-matching systems to proactive content-generating technologies that can engage in open-ended tasks.

The adoption of generative AI systems has accelerated dramatically across numerous industries due to their versatility and ability to automate complex cognitive tasks. In customer support, generative AI systems power intelligent chatbots that can formulate natural responses to inquiries without human intervention. Healthcare organizations utilize generative AI systems to draft clinical documentation, summarize research literature, and assist in diagnostic processes. Financial institutions employ generative AI systems for automated reporting, risk assessment, and personalized financial advice. Software development has been transformed through AI-assisted coding, documentation generation, and bug detection. Additional sectors including legal services, content creation, education, and manufacturing are similarly integrating generative AI systems to enhance productivity and service delivery.

Despite their impressive capabilities, generative AI systems occasionally produce outputs characterized as “hallucinations”—plausible-sounding but factually incorrect or nonsensical information. These hallucinations occur when the model generates content that extends beyond its training data or makes connections that appear logical but lack factual basis. This phenomenon presents significant challenges in applications where accuracy is critical, such as healthcare diagnostics, legal document preparation, or financial advising.

### BRIEF DESCRIPTION OF DRAWINGS

Various examples in accordance with the present disclosure will be described with reference to the drawings, in which:

FIG. 1A depicts a high level overview of a provider network, according to implementations of the present disclosure.

FIG. 1B depicts a high level overview of another provider network and an environment that includes a third party provider and services, according to implementations of the present disclosure.

FIG. 2 is a block diagram providing additional details of an observability layer of FIGS. 1A and 1B that verifies requests and responses of agents and endpoints, according to implementations of the present disclosure.

FIGS. 3-7 are transition diagrams illustrating requests and responses between a primary requester, AI agent(s), and endpoint(s) that are verified by an observability layer, according to implementations of the present disclosure.

FIG. 8 is an example agent request verification process performed by an observability layer, according to implementations of the present disclosure.

FIG. 9 is an example endpoint response verification process performed by an observability layer, according to implementations of the present disclosure.

FIG. 10 is an example agent response verification process performed by an observability layer, according to implementations of the present disclosure.

FIG. 11 is an example guardrail verifier process performed by an observability layer, according to implementations of the present disclosure.

FIG. 12 is an example state tracker process performed by an observability layer, according to implementations of the present disclosure.

FIG. 13 is an example anomaly detection process performed by the provider network, according to implementations of the present disclosure.

FIG. 14 illustrates an example provider network environment on which some or all of the observability layer can be implemented, according to implementations of the present disclosure.

FIG. 15 is a block diagram of an example provider network that provides a storage service and a hardware virtualization service to customers, on which some or all of the observability layer can be implemented, according to implementations of the present disclosure.

FIG. 16 is a block diagram illustrating an example computing system that can be used in some examples.

### DETAILED DESCRIPTION

Disclosed are methods and systems that include an observability layer that receives and observes requests and responses into and out of an AI backed agent, referred to herein as an “AI agent.” As discussed further below, any of a variety of primary requesters, such as users, other AI agents, other software systems, Internet of Things (“IoT”) devices, monitoring systems, event driven systems, etc., may submit a primary request to an AI agent. The AI agent, in generating an agent response to the primary request may, in some examples, generate one or more agent requests, such as an Application Programming Interface (“API”) request, that are sent from the AI agent to one or more endpoints. The endpoints in turn, respond to the agent request with an endpoint response that includes information responsive to the agent request. The AI agent utilizes the received endpoint response(s) to generate and return to the primary requester an agent response that is responsive to the primary request.

As discussed herein, the observability layer (or observer in some examples) receives and observes agent requests generated by the AI agent, endpoint responses sent by endpoints to the AI agent, and agent responses generated by the AI agent for delivery to the primary requester. As part of the observation, the observability layer determines if a received agent request, such as an API request, includes a hallucination generated by the AI agent. If the observability layer determines that the agent request does not include any hallucinations, the observability layer may pass the agent request to the intended endpoint for execution. However, if the observability layer determines that the agent request includes a hallucination, the observability layer intervenes, prohibiting the endpoint from receiving the agent request and sending an error message back to the agent to resolve the hallucination. In some implementations, the observability layer, when creating the error message, may follow a defined schema of the endpoint to which the agent request was intended so that the message appears to have been sent by the endpoint and observability layer remains unknown or invisible to the AI agent. In other implementations, at least a portion of the observability layer is known to all or a subset of the AI agent(s) in the agentic network and the AI agent(s) with awareness to the observability layer may communicate directly with the observability layer.

Still further, the observability layer also receives and observes endpoint responses sent from endpoints back to the AI agent. As part of the observation of endpoint responses, the observability layer determines if the endpoint response is responsive to the agent request sent to the endpoint. If the observability layer determines that the endpoint response is responsive to the agent request, the observability layer passes the endpoint response to the AI agent. If the observability layer determines that the endpoint response is not responsive to the agent request, the observability layer prohibits the AI agent from receiving the endpoint response and instead returns to the AI agent an error message that follows the schema of the endpoint indicating that the endpoint is unavailable. By generating error message following the schema of the endpoint, the AI agent receives the error message as if the error message was sent by the endpoint, thereby keeping the observability layer invisible to the AI agent.

By generating error messages following the schema of the endpoint, the error message, from the perspective of the AI agent, appears to have been sent by the endpoint. As a result, the observability layer remains hidden or invisible to the endpoint. Keeping the observability layer hidden or invisible to the AI agent may be beneficial. For example, the AI agent may not expect a response from an entity other than the endpoint to which the agent request was sent. Upon receipt of an unexpected response from the observability layer, the AI agent may become unpredictable, fail, or not recover from the error message as intended. In other implementations, for example, with more sophisticated AI agents, selectively making the observability layer visible and known to certain AIs agent may be beneficial as additional information and guidance may be provided by the observability layer to help guide certain AI agents toward an appropriate resolution of the error in an agentic network.

The error message generated and sent by the observability layer may cause the AI agent to issue another endpoint request to the same or different endpoint in an effort to obtain the desired response/information. Further, the observability layer may constrain the endpoint that provided the endpoint response that is not responsive to the agent request. As part of constraining the endpoint, the observability layer may, for example, suspend the endpoint, isolate the endpoint, remove the endpoint from an availability list accessible by AI agents, terminate the endpoint, restart the endpoint, etc. An operator may also be notified of the constraint so that the operator can take efforts to resolve or restore the agent/endpoint.

In still further examples, the observability layer also observes agent responses to the primary requester. As part of the observation of the agent response, the observability layer determines if the agent response to the primary requester includes a hallucination. Additionally, in some implementations, the observability layer may further determine if the agent response is responsive to the primary request. If the observability layer determines that the agent response does not include any hallucinations and is responsive to the primary request (i.e., is an accurate response), the observability layer passes the agent response to the primary requester as responsive to the primary request. If the observability layer determines that the agent response includes a hallucination and/or is not responsive to the primary request (i.e., is an inaccurate response), the observability layer prohibits the primary requester from receiving the agent response. Additionally, the observability layer may send an error message back to the AI agent indicating that the agent response is not responsive to the primary request and/or includes a hallucination. In such a case, the error message may be formatted by the observability layer in such a way that the AI agent would recognize the error message came from the intended target, and now aware that the prior message has been intercepted by the observability layer. As an example, the error message generated and sent by the observability layer back to the AI agent may be generated according to a schema of the primary requester (e.g., if the primary requester is another AI agent or another computing system) such that the AI agent receives the error message as if it were sent by the primary requester, thereby keeping the observability layer invisible to the AI agent. If the primary requester is a user (e.g., human), the error message may be generated as a natural language response similar to that which may be generated by the user.

In some implementations, instead of sending an error message back to the AI agent, the observability layer may constrain (e.g., suspend, isolate, terminate, restart, etc.) the AI agent. If the observability layer constrains the AI agent, the primary request may be provided to a second AI agent so that the second AI agent can generate and return a response to the primary request.

As discussed herein, an AI agent, such as a Large Language Model (“LLM”)-backed agent, comprises a software system that leverages AI to autonomously perform complex tasks through a combination of reasoning capabilities and action execution. The AI agent integrates AI, such as an LLM, as its cognitive engine, which processes natural language inputs (e.g., primary requests), generates contextually appropriate outputs, and determines logical sequences of actions to be performed. The AI agent maintains an execution framework that translates the AI’s decisions into concrete operations within designated environments, such as accessing databases, manipulating files, or interfacing with external endpoints through API calls. The AI agent may also include a memory component that preserves state information across interactions, enabling the AI agent to build upon previous context and maintain coherent task progression. This architecture of an AI agent enables the AI agent to handle sophisticated workflows involving multiple steps and decision points. However, as is known, AI agents may hallucinate.

Comparatively, as discussed herein, verifiers or verification components of the observability layer that observe and verify different aspects of requests and responses into and out of AI agents, may be based on more traditional ML models, such as neural networks and/or may be rule based. Such models and/or rules are trained to make predictions or classifications based on inputs and, as a result, do not hallucinate. By utilizing more traditional ML models, such as neural networks, that do not hallucinate, to operate as verification components of the observability layer, the disclosed implementations are able to verify, among other things discussed herein, that requests and responses into and out of AI agents do not contain hallucinations, that responses are actually responsive to a request, and to automatically take corrective action when needed.

While the examples discussed herein, for ease and clarity of discussion, primarily focus on an observability layer observing requests and responses into and out of an AI agent, it will appreciated that the disclosed implementations may be utilized in an agentic network that includes multiple AI agents that may be working together, for example, each with specific roles and capabilities, to accomplish complex tasks through collaboration. In such a configuration, in some instances, an AI agent by be a primary requester to another AI agent, an endpoint receiving a request from another AI agent, etc. Regardless of the configuration, the disclosed implementations of an observability layer are operable to observe requests and responses into and out of one or more AI agents and intervene when needed, as discussed herein.

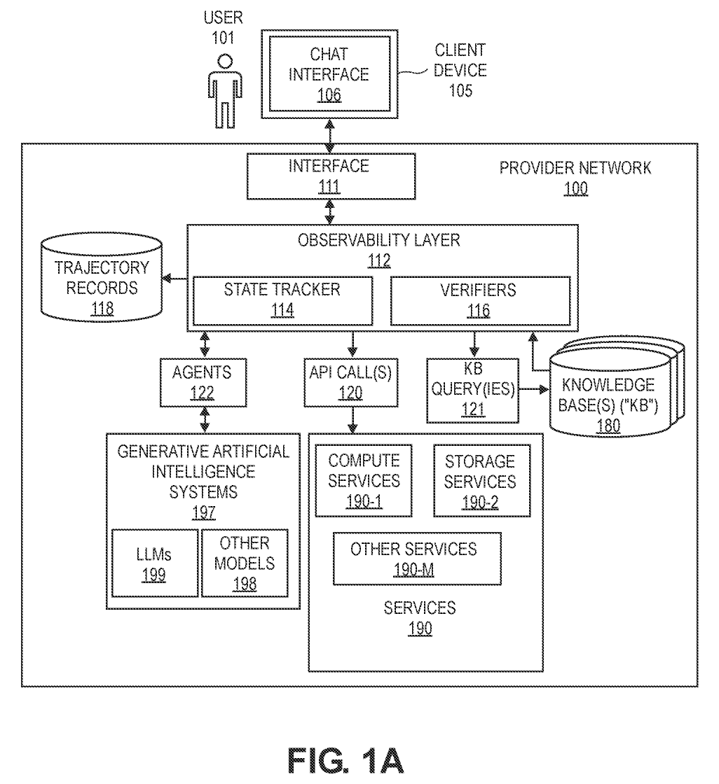

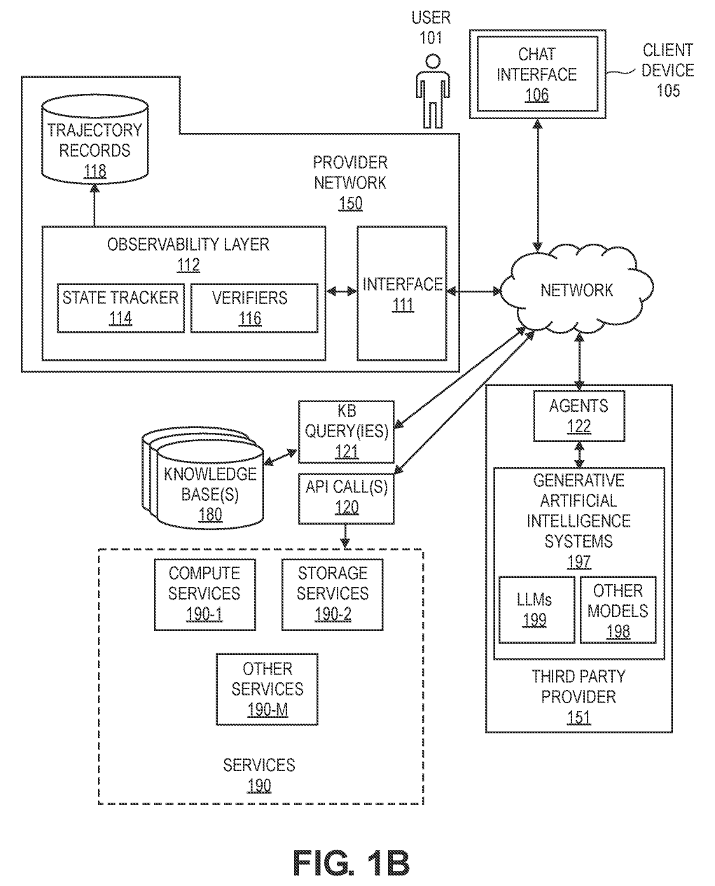

FIG. 1A depicts a high level overview of a provider network 100, according to implementations of the present disclosure.

As illustrated, the provider network 100 supports interaction between a user 101 utilizing a chat interface 106 executing on a client device 105. The provider network 100 may provide any number of services, agents, etc., to or for the user 101. For example, the user 101 may interact with one or more agents 122 that are backed by one or more generative AI systems 197. The agents 122 each include a software system that leverages one or more generative AI systems 197, such as LLMs 199 and/or other models 198, as its cognitive engine, which process natural langue inputs, generate contextually appropriate outputs, and determine logical sequences of actions to be performed. Through interaction with one or more generative AI systems 197, agents 122 can determine and generate agent requests, such as API calls and/or knowledge base (“KB”) queries 121 to obtain information needed by the agent 122 to produce a response to a primary request from the user 101.

As discussed further herein, the observability layer 112, which includes a state tracker 114 and one or more verifiers 116, also referred to herein as verifier components, in the illustrated example, is included in the provider network 100 with the one or more agents 122 and provides a service of ensuring that the responses and requests into and out of the agents do not include hallucinations and are otherwise appropriate (e.g., proper protocol, proper schema, responsive, etc.). Specifically, the verifiers 116 receive and observe the responses and requests received into and out of the agents 122 and process those responses and requests to verify that the responses and requests do not include hallucinations, are actually responsive to the request, and are otherwise accurate. For example, a first verification component 116 may receive an agent request in the form of an API call 120 or a knowledge base query 121 that is to be sent to an endpoint, such as a service 190 and/or a knowledge base (“KB”) 180 to illicit a response from the endpoint that maybe used by the agent 122 to produce a response that is responsive to the primary request from the user 101. The agent request will be formatted according to the schema of the endpoint. For example, if the endpoint follows the OpenAPI specification, the schema of the OpenAPI specification will be followed when generated the agent request. Likewise, when responses, such as endpoint responses and/or agent responses are generated, the responses will follow the schema specified for the computing system/recipient to which the response is being sent. The verification component 116 may process the received agent request to determine if the agent request potentially includes a hallucination and/or to verify that the hallucination request conforms to one or more protocols, structures, schemas, etc., of the endpoint.

As each request and/or response into and out of the agents 122 is sent/received, the state tracker 114 updates trajectory records 118 and maintains a state of the responses and requests for each session with a user 101. In some implementations, the state tracker may also generate a summary of the trajectory records for the session. The summary records may be used to identify potentially unhealthy endpoints and/or agents, repetitive requests by an agent, etc.

One common environment for an observability layer is a provider network 100. A provider network 100 (or, “cloud” provider network) provides users with the ability to use one or more of a variety of types of computing-related resources such as compute resources (e.g., executing virtual machine (“VM”) instances and/or containers, executing batch jobs, executing code without provisioning servers), data/storage resources (e.g., object storage, block-level storage, data archival storage, databases and database tables, etc.), network-related resources (e.g., configuring virtual networks including groups of compute resources, content delivery networks (“CDNs”), Domain Name Service (“DNS”)), application resources (e.g., databases, application build/deployment services), access policies or roles, identity policies or roles, machine images, routers and other data processing resources, etc. These and other computing resources can be provided as services, such as a hardware virtualization service that can execute compute instances, a storage service that can store data objects, etc. The users 101 (or “customers”) of provider networks 100 can use one or more user accounts that are associated with a customer account, though these terms can be used somewhat interchangeably depending upon the context of use. Users 101 can interact with a provider network 100 via one or more interface(s), such as through use of API calls, via a chat interface 106 implemented as a website or application, etc., on a client device 105, etc.

An API refers to an interface and/or communication protocol and schema between a source and an endpoint, such as a server, such that if the source makes a request in a predefined format according to the schema, the source should receive a response in a specific format according to the schema or initiate a defined action. In the cloud provider network context, APIs provide a gateway for customers to access cloud infrastructure by allowing customers to obtain data from or cause actions within the cloud provider network, enabling the development of applications that interact with resources and services hosted in the cloud provider network. APIs can also enable agents 122 to communicate with endpoints, such as compute services 190-1, storage services 190-2, through any number of other services 190-M, generally referred to herein as service(s) 190.

A cloud provider network (or just “cloud”) typically refers to a large pool of accessible virtualized computing resources (such as compute, storage, and networking resources, applications, and services). A cloud can provide convenient, on-demand network access to a shared pool of configurable computing resources that can be programmatically provisioned and released in response to customer commands. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services.

Cloud provider networks often provide access to computing resources via a defined set of regions, availability zones, and/or other defined physical locations where a cloud provider network clusters data centers. In many cases, each region represents a geographic area (e.g., a U.S. East region, a U.S. West region, an Asia Pacific region, and the like) that is physically separate from other regions, where each region can include two or more availability zones connected to one another via a private high-speed network, e.g., a fiber communication connection. An availability zone (also known as an availability domain, or simply a “zone”) refers to an isolated failure domain including one or more data center facilities with separate power, separate networking, and separate cooling from those in another availability zone. Preferably, availability zones within a region are positioned far enough away from one another that the same natural disaster should not take more than one availability zone offline at the same time, but close enough together to meet a latency requirement for intra-region communications. The data centers house physical computing devices (e.g., suitable types of servers) that host the bare metal and virtualized resources (e.g., compute, networking, & storage) on which cloud services and customer workloads run.

Furthermore, regions of a cloud provider network are connected to a global “backbone” network which includes private networking infrastructure (e.g., fiber connections controlled by the cloud provider) connecting each region to at least one other region. This infrastructure design enables users of a cloud provider network to design their applications to run in multiple physical availability zones and/or multiple regions to achieve greater fault-tolerance and availability. For example, because the various regions and physical availability zones of a cloud provider network are connected to each other with fast, low-latency networking, users can architect applications that automatically failover between regions and physical availability zones with minimal or no interruption to users of the applications should an outage or impairment occur in any particular region.

To provide these and other computing resource services, provider networks 100 often rely upon virtualization techniques. For example, virtualization technologies can provide users the ability to control or use compute resources (e.g., a “compute instance,” such as a VM using a guest operating system (O/S) that operates using a hypervisor that might or might not further operate on top of an underlying host O/S, a container that might or might not operate in a VM, a compute instance that can execute on “bare metal” hardware without an underlying hypervisor), where one or multiple compute resources can be implemented using a single electronic device. Thus, a user can directly use a compute resource (e.g., provided by a hardware virtualization service) hosted by the provider network to perform a variety of computing tasks. Additionally, or alternatively, a user can indirectly use a compute resource by submitting code to be executed by the provider network (e.g., via an on-demand code execution service), which in turn uses one or more compute resources to execute the code - typically without the user having any control of or knowledge of the underlying compute instance(s) involved.

Further, a user 101 may, via the chat interface 106 of the client device 105, interact directly with one or more agents 122. Agents may provide any of a variety of services or experiences for the user. For example, agents may be used in the financial industry to aid a user in banking, loan applications, tax reporting, risk assessment, financial advice, etc. In the healthcare sector, agents 122 may function to provide medical guidance to users 101, assist in diagnostic processes, summarize research literature, draft clinical documents, etc. As can be appreciated, agents 122 offer ever changing and expanding forms of interaction and support for a user and/or other requesters.

As illustrated, the provider network 110 includes an interface 111 that provides different entry points for clients to interact with agents 122. A user 101 interacts with an agent 122 via an electronic device 105. The electronic device 105 can display, for example, a chat-based interface 106 and/or other forms of interfaces. The chat interface 106 sends and receives data via the interface 111 of the provider network 100. The chat-based interface 106 can be part of a graphical user interface providing a “chat” type interface commonly associated with LLMs in which users can type text and receive responses.

The interface 111 can also provide a more programmatic entry point for other applications or services such as an issue management service (also sometimes referred to as issue tracking service), a logging service of the provider network, or the application displaying the interface 106 (e.g., a software development environment or issue management application executed by the electronic device 105). API calls via these type entry points can include, like the chat-based interface, free-form text (e.g., bug descriptions or change requests from an issue tracking system, error messages from the logging service, etc.) but further include additional contextual parameters available to the application or application environment issuing the call (e.g., an identification of the code repository associated with a particular software change request, an identification of the cloud-hosted instance generating a log entry, etc.).

Generally speaking, the interface 111 can provide for interactions with various clients, including human users, such as user 101, via interfaces 106 and with other applications such as software development environments, software management systems, issue tracking systems, financial systems, healthcare systems, other agents 122, etc. Such systems may be hosted or executed on the provider network 100, in whole or in part. In other examples, some or all systems may be hosted on a different third party provider network, as discussed below.

The provider network 100 can support multi-tenancy, allowing multiple clients to connect and interact with agents 122. Each client can have one or more sessions with the provider network 100, the sessions corresponding to sessions with one or more agents 122. To do so, the state tracker 114 can track, for a given session, the last N requests sent to an agent 122, agent requests sent to one or more endpoints by the agent 122, endpoint responses received from endpoints in response to agent requests, and agent responses generated by the agent 122 for delivery to the client (primary requester) as responsive to a primary request sent by the primary requester.

Generative AI systems 197 include LLMs 199 and other models 198. LLMs are artificial intelligence systems designed to understand and generate human-like text. These models are trained using machine learning techniques, typically on vast amounts of text data from the internet, books, articles, and other sources. Often, LLMs use a type of neural network called a transformer to process and understand the patterns and structures of language. Exemplary LLMs include Amazon’s Titan®, Anthropic’s Claude 3.5 Sonnet, etc. As noted above, LLMs may be used as the cognitive engine of an agent so that the agent can perform complex tasks through a combination of reasoning capabilities and action execution. Other models 198 can include code generation models, which may be within the same family as LLMs but trained and/or fine-tuned on a corpus more narrowly curated to specific services offered or supported by one or more agents rather than general texts encompassing a range of other fields.

FIG. 1B depicts a high level overview of another provider network 150 and an environment that includes a third party provider 151 and services 190 that are separate from the provider network 150, according to implementations of the present disclosure.

In the example illustrated in FIG. 1B, the provider network 150 provides the observability layer to observe and verify requests and responses into and out of agents 122 that are executing on a network that is separate and independent from the provider network 150. Likewise, some or all of the services 190 and/or knowledges base(s) 180 may also be separate from the provider network 150. In such a configuration, rather than requests and responses into and out of the agents being performed and transmitted on the provider network 150, as illustrated in FIG. 1A, the requests and responses into and out of the agents 122 may originate separate from the provider network 150 and be transmitted, for example, through the provider network 150. In such a configuration, the third party provider 151 may utilize the observability layer 112 of the provider network 150 as a service to ensure the accuracy of the agents 122. Accordingly, much like the configuration discussed with respect to FIG. 1A, the requests and responses into and out of the agents 122 are received at the observability layer 112 and verified to determine if the request/response includes a hallucination, is responsive to the request, etc.

As such, it will be appreciated that the disclosed implementations may provide an observability layer 122 for agents operating on the provider network with the observability layer and/or for agents 122 operating in other computing environments, such as a third party provider 151.

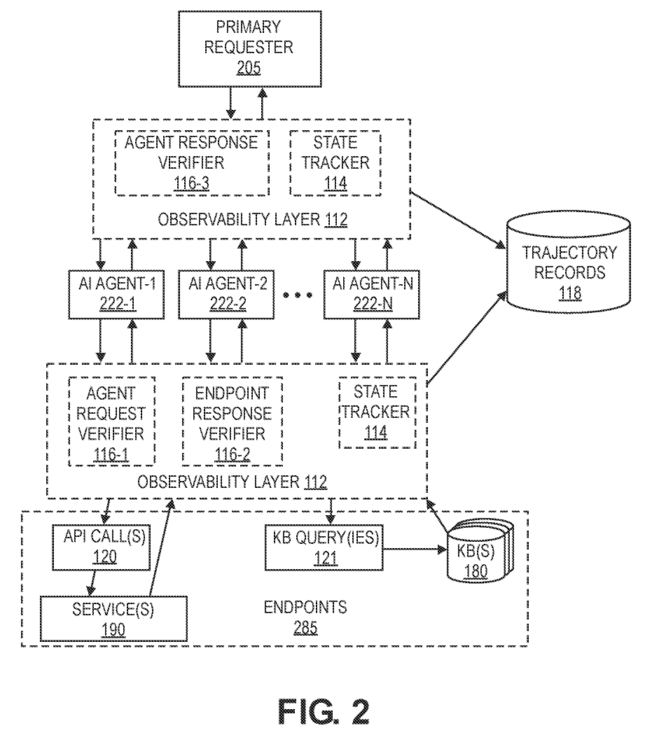

For purposes of the disclosure and to facilitate discussion and consistency, FIG. 2 is a block diagram providing additional details of an observability layer 112 of FIGS. 1A and 1B that observes requests and responses of AI agents 222-1, 222-2, through 222-N and endpoints 285, such as service(s) 190 and/or knowledge base(s) 180, according to implementations of the present disclosure.

For this disclosure, the entity submitting a primary request to an AI agent, such as AI agent-1 222-1, AI agent-2 222-2, through AI agent-N 222-N, is referred to as a primary requester 205. A primary requester 205 may be a user communicating with an AI agent via a chat interface, as discussed above with respect to FIGS. 1A and 1B, another AI agent, other software systems, IoT devices, monitoring systems, event driven systems, robotic systems, etc. As discussed, the AI agent, as used herein includes software system and the generative AI system leveraged by the software system to autonomously perform tasks assigned to the AI agent, such as responding to a primary request from a primary requester.

When a primary requester 205 submits a primary request to an AI agent, such as AI agent-1 222-1, the primary request is observed by the observability layer 112, added to the trajectory records 118 by the state tracker 114, and passed to the intended AI agent, in this example AI agent-1 222-1. The AI agent-1 222-1, processes the primary request using the leveraged generative AI system (e.g., LLM) to determine a sequence of actions to be performed by the AI agent to gather information, perform actions, etc., that are necessary to respond to the primary request. Such sequence may include the AI agent generating and sending one or more agent requests, such as API call(s) 120 or KB query(ies) 121 that are sent to one or more endpoints 285, such as service(s) 190 and knowledge base(s) 180.

As each agent request is generated and sent from the AI agent, the observability layer 112 receives the agent request prior to receipt of the agent request by the intended endpoint. The agent request verifier 116-1 of the observability layer 112 then processes the request to determine if the request potentially includes a hallucination. In some implementations, the agent request verifier 116-1 may also determine, for example, if the agent request is a repetitive request that has already been answered by the endpoint, if the agent request follows a defined schema for the endpoint, if the agent request follows a defined protocol for the endpoint, etc. For example, if the agent request is an API call, the agent request verifier 116-1, may utilize a rules based engine and/or a neural network to verify that the defined schema of the API for the endpoint is followed in the agent request. As another example, some endpoints 285 have defined protocols that are to be followed. For example, if the endpoint is an airline reservation service, the endpoint may have a protocol that a first request is to be sent to determine if seats are available for purchase on a flight and that a second, subsequent request, is to be sent to purchase an available seat. In such an example, if an agent request is generated and sent by the AI agent requesting to purchase a seat on the flight, the agent request verifier 116-1 will, upon receipt of that message, determine that the AI agent is following the protocol for the endpoint and has already submitted a previous agent request to confirm that a seat is available for purchase on the flight. To determine if the AI agent has followed the protocol, in some examples, the agent request verifier may obtain information from the state tracker 114 and/or the trajectory records 118.

If the agent request verifier 116-1 verifies that the agent request is accurate (e.g., does not include a hallucination, follows the schema and protocol of the endpoint, etc.), the observability layer 112 passes the agent request to the endpoint and the trajectory records 118 are updated. If the agent request verifier 116-1 determines that the agent request is inaccurate (e.g., does not follow the schema and/or protocol of the endpoint, includes a hallucination, etc.), the agent request verifier 116-1 refrains from forwarding the agent request to the endpoint 285 and sends an error message back to the AI agent indicating the determined error. The intent of the error message is to cause the AI agent to perform self-reflection, resolve the error, and resubmit a second agent request that does not include the error. Accordingly, in some implementations, to keep the observability layer invisible to the AI agent (e.g., to avoid potential confusion by the agent), the error message may be generated to follow the defined schema of the endpoint for which the agent message was intended. For example, if the endpoint follows the OpenAPI specifications, the error message will be generated to follow the schema specified in the OpenAPI specification documentation. For example, the error message may include a message field that includes a human readable error description (e.g., “the agent request includes a hallucination regarding XXXX information in the agent request”), a machine-readable error code (e.g., 400, 401, 403, 404, 422), a detail or error file indicating any specific validation issues, a path field indicating where the error occurred, and a type field indicating an error classification. In some implementations, alternative, additional, or less information may be included, depending on the schema specified in the API documentation. For example, more sophisticated APIs might allow for additional information, such as suggested fixes to the error.

In some implementations, keeping the observability layer hidden or unknown to the AI agent may be beneficial. For example, the AI agent may not expect a response from an entity other than the endpoint to which the agent request was sent. Upon receipt of an unexpected response from the observability layer, the AI agent may become unpredictable, fail, or not recover from the error message as intended. In other implementations, for example, with more sophisticated AI agents, selectively making the observability layer visible and known to certain AIs agent may be beneficial as additional information and guidance may be provided by the observability layer to help guide certain AI agents toward an appropriate resolution of the error in an agentic network.

The endpoints 285, in response to a received agent request, process the request and provide an endpoint response to the AI agent. Like the agent request, the endpoint response is received by the observability layer 112 prior to the AI agent-1 222-1 receiving the endpoint response. The endpoint response verifier 116-2 processes the endpoint response to verify that the endpoint response is responsive to the agent request, does not include a hallucination, and is otherwise accurate. If the endpoint response verifier 116-2 determines that the endpoint response is accurate, the observability layer 112 passes the endpoint response to the AI agent-1 222-1. If the endpoint response verifier 116-2 determines that the endpoint response is not received within a predetermined time (e.g., 5 seconds, 30 seconds, 1 minute, etc.) or is inaccurate (e.g., is not responsive to the agent request, includes a hallucination, etc.), the observability layer 112 refrains from passing the endpoint response to the AI agent-1 222-1. Instead, the observability layer generates and sends an error message to the AI agent-1 222-1 indicating that the endpoint is unavailable. Like the other messages generated and sent by the observability layer, the error message is generated according to the schema of the endpoint such that the AI agent receives the error message as if it were generated by the endpoint, thereby keeping the observability layer invisible to the AI agent. Additionally, the observability layer 112 may constrain the endpoint by, for example, isolating the endpoint, terminating the endpoint, restarting the endpoint, removing the endpoint from a list of available endpoints, etc. If the endpoint is constrained, the observability layer may also provide a notification to an operator so that the operator can take steps to adjust the endpoint, resolve the cause of the error, and reintroduce the endpoint for use by AI agents.

The intent of sending the error message to the AI agent-1 222-1 indicating that the endpoint is unavailable is to cause the AI agent to generate and send a second agent request in an effort to obtain the necessary information. Accordingly, if it is determined that the endpoint response is not received within a predetermined time (e.g., 5 seconds, 30 seconds, 1 minute, etc.) or is inaccurate (e.g., includes a hallucination, is not responsive to the request, etc.) the error message indicating that the endpoint is unavailable may be structured in a defined form, such as according to the schema of the endpoint, to keep the observability layer invisible from the perspective of the AI agent. In other examples, the error message format may be different, and the observability layer may be visible to the AI agent.

The AI agent-1 222-1, upon receipt of the endpoint response(s), generates an agent response to be sent to the primary requester 205. The agent response sent by the AI agent-1 222-1 is received by the observability layer prior to the primary requester 205 receiving the agent response. The agent response verifier 116-3 process the agent response to verify that the agent response is accurate (e.g., does not include any hallucinations, is responsive to the primary request, etc.). If the agent response verifier 116-3 verifies that the agent response is accurate, the observability layer 112 passes the agent response to the primary requester 205 as responsive to the primary request. If the agent response verifier determines that the agent response is inaccurate (e.g., includes a hallucination, is not responsive to the primary request, etc.), the observability layer 112 generates and sends an error message to the AI agent indicating that the agent response includes a hallucination/is not responsive to the primary request. As with the other error messages generated by the observability layer, the error message may be formatted such that the observability layer remains invisible to the AI agent. For example, if the primary request was from another computing system, such as another agent, compute service, etc., the error message may be structured according to the schema of that other computing system. If the primary request is from a user, the error message may be structured in the form of a natural language response that reflects a potential response from the user, such that the AI agent receives the error message as if it were a response from the user 101. As discussed further herein, by generating an error message sent back to the AI agent such that the error message appears, at least to the AI agent, as having been generated by the primary requester, whether that be another AI agent/computing system or a user, the observability layer 112 remains invisible to the AI agent 122/222.

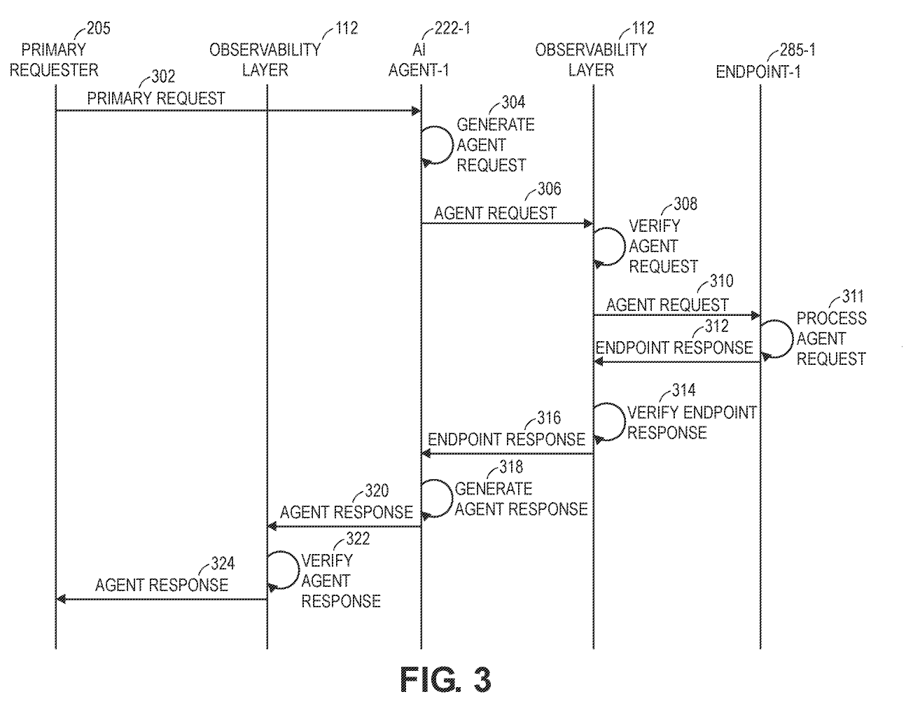

FIGS. 3-7 are transition diagrams illustrating requests and responses between a primary requester 205, AI agent(s), and endpoint(s) that are verified by an observability layer 112, according to implementations of the present disclosure.

Turning first to FIG. 3, illustrated is a transition diagram in which all requests and responses into and out of the AI agent are verified. Initially, the primary requester 205 sends a primary request 302 to AI agent-1 222-1 and the AI agent-1 222-1 generates 304 an agent request for an endpoint. The agent request is sent 306 from the AI agent-1 222-1 and received by the observability layer 112 prior to the endpoint-1 285-1 receiving the agent request. The observability layer 112 then processes the agent request and, in this example, verifies 308 that the agent request is accurate (e.g., not repetitive, follows the schema of the endpoint, follows the protocol of the endpoint, does not include a hallucination, etc.). Upon verifying the agent request, the observability layer 112 passes 310 the agent request to the endpoint-1 285-1. The endpoint-1 285-1 processes 311 the agent request to produce and send 312 an endpoint response.

The observability layer 112 receives the endpoint response sent by the endpoint-1 285-1 prior to the AI agent-1 222-1 receiving the endpoint response and processes the endpoint response to verify 314 that the endpoint response is accurate (e.g., is responsive to the agent request, does not include a hallucination, etc.). Upon verifying that the endpoint response is accurate, the observability layer 112 passes 316 the endpoint response to the AI agent-1 222-1.

The AI agent-1 222-1, upon receipt of the endpoint response, generates 318 an agent response based at least in part on the endpoint response. The AI agent-1 222-1 then sends 320 the agent response, which is received by the observability layer 112 prior to the primary requester receiving the agent response. In some examples, if the AI agent sent out multiple agent requests to different endpoints, the AI agent may wait until all necessary endpoint responses are received prior to the AI agent generating and sending the agent response.

The observability layer 112, upon receipt of the agent response, processes the agent response to verify 322 that the agent response is accurate (e.g., does not include a hallucination, is responsive to the primary request, etc.). Upon verifying that the agent response is accurate, the observability layer 112 sends 324 the agent response to the primary requester 205 as responsive to the primary request. In some implementations, the observability layer 112 (e.g., observer 112-A, not currently depicted) between the primary requestor and AI Agent-1 222-1 is isolated/independent from the observability layer 112 (e.g., observer 112-B, not currently depicted) between the AI Agent-1 222-1 and endpoint-1 285-1. In some implementations, it is advantageous for the observability to be specialized in certain communication channels (e.g., observer 112-A specializes in communications between primary requesters and AI agents, observer 112-B specializes in communications between AI agents and endpoints/APIs) and be modular, so that a single system failure will not bring down the whole observability layer 112. Specialized observers can also take advantage of the latest features available for that specific communication network. Modular construction would also enable the observability layer to be updated sectionally. For example, when a new observer 112-B is available, it can be swapped with the old observer 112-B to update the overall observability layer (while keeping observer 112-A running) instead of taking the whole observability layer 112 offline to perform the update.

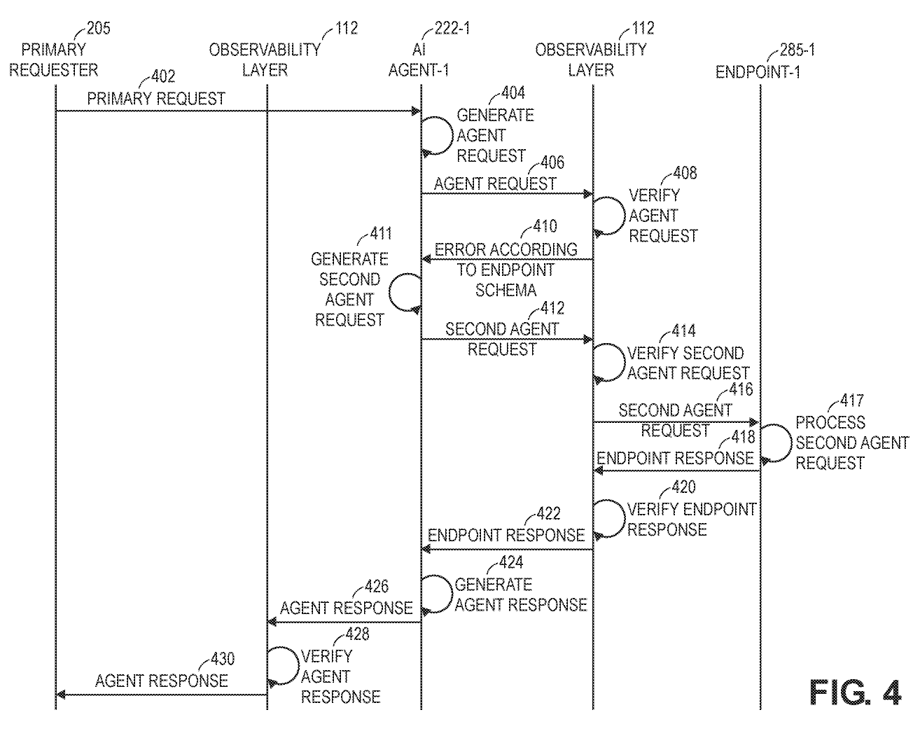

FIG. 4 illustrates a transition diagram in which the first agent request is not verified. Initially, the primary requester 205 sends a primary request 402 to AI agent-1222-1 and the AI agent-1 222-1 generates 404 an agent request for an endpoint. The agent request is sent 406 from the AI agent-1 222-1 and received by the observability layer 112 prior to the endpoint-1 285-1 receiving the agent request. The observability layer 112 then processes 408 the agent request and, in this example, determines that the agent request is inaccurate. For example, the observability layer may determine that the agent request is repetitive, does not comply with the schema of the endpoint-1 285-1, does not follow the protocol of endpoint-1 285-1, and/or includes a hallucination. Upon determining that the agent request is inaccurate, the observability layer 112 generates and sends 410 an error message that corresponds to the endpoint schema of the endpoint-1 285-1, thereby making the observability layer invisible to the AI agent. The error message may indicate the error(s) determined by the observability layer 112 when attempting to verify the agent request.

The AI agent, upon receipt of the error message, generates 411 a second agent request for the endpoint-1 285-1 that resolves the error(s) indicated in the error message. The second agent request is then sent 412 from the AI agent-1 222-1 and received by the observability layer 112 before the second agent request is received by the endpoint-1 285-1. The observability layer 112 then processes 414 the second agent request and, in this example, verifies 414 that the second agent request is accurate. Once verified as accurate, the observability layer 112 sends 416 the second agent request to the endpoint-1 285-1. The endpoint-1 285-1 processes 417 the second agent request to produce and send 418 an endpoint response.

The observability layer 112 receives the endpoint response sent by the endpoint-1 285-1 prior to the AI agent-1 222-1 receiving the endpoint response and processes the endpoint response to verify 420 that the endpoint response is accurate (e.g., is responsive to the agent request, does not include a hallucination, etc.). Upon verifying that the endpoint response is accurate, the observability layer 112 passes 422 the endpoint response to the AI agent-1 222-1.

The AI agent-1 222-1, upon receipt of the endpoint response, generates 424 an agent response based at least in part on the endpoint response. The AI agent-1222-1 then sends 426 the agent response, which is received by the observability layer 112 prior to the primary requester receiving the agent response. In some examples, if the AI agent sent out multiple agent requests to different endpoints, the AI agent may wait until all necessary endpoint responses are received prior to the AI agent generating and sending the agent response.

The observability layer 112, upon receipt of the agent response, processes the agent response to verify 428 that the agent response is accurate (e.g., does not include a hallucination, is responsive to the primary request, etc.). Upon verifying the agent response, the observability layer 112 sends 430 the agent response to the primary requester 205 as responsive to the primary request.

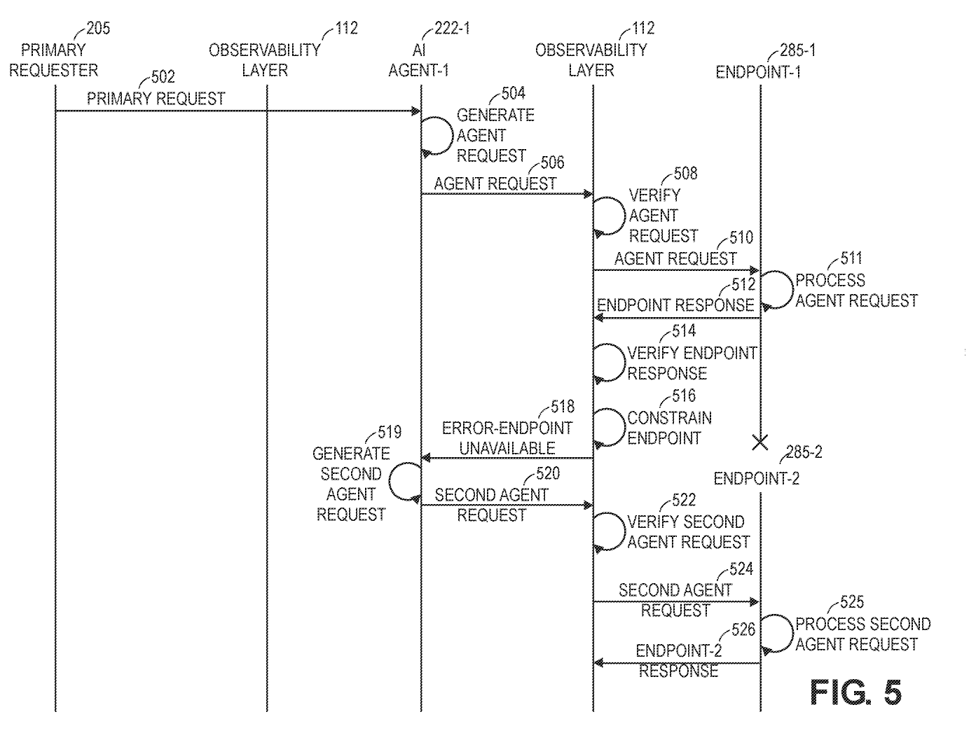

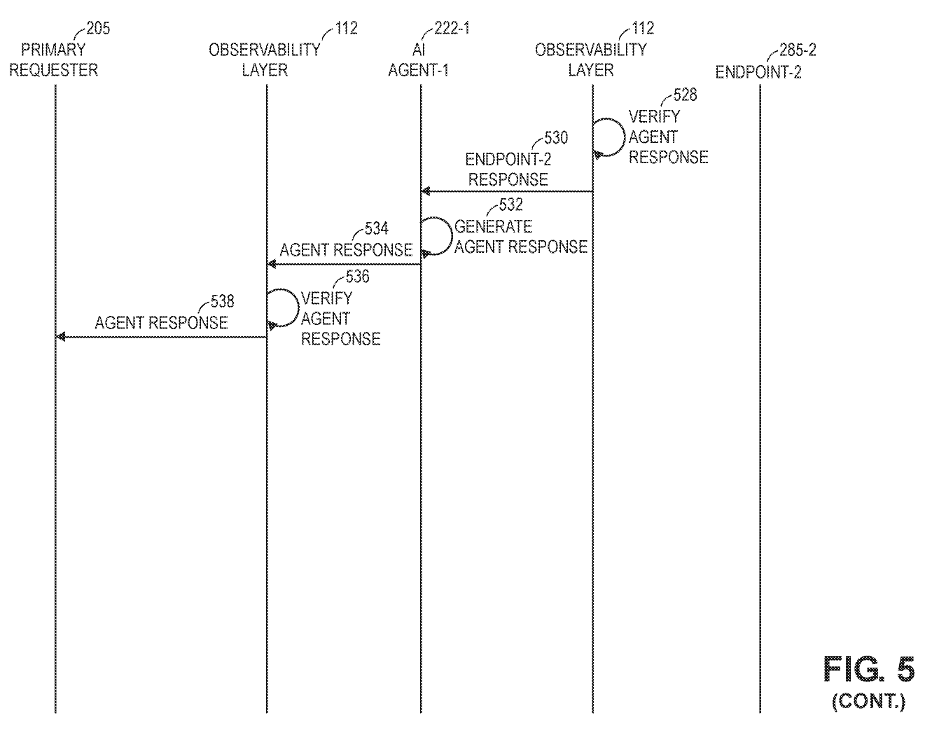

FIG. 5 illustrates a transition diagram in which the first endpoint response is not verified. Initially, the primary requester 205 sends a primary request 502 to AI agent-1 222-1 and the AI agent-1 222-1 generates 504 an agent request for an endpoint. The agent request is sent 506 from the AI agent-1 222-1 and received by the observability layer 112 prior to the endpoint-1 285-1 receiving the agent request. The observability layer 112 then processes the agent request and, in this example, verifies 508 that the agent request is accurate (e.g., not repetitive, follows the schema and protocol of the endpoint, does not include a hallucination, etc.). Upon verifying that the agent request is accurate, the observability layer 112 passes 510 the agent request to the endpoint-1 285-1. The endpoint-1 285-1 processes 511 the agent request to produce and send 512 an endpoint response.

The observability layer 112 receives the endpoint response sent by the endpoint-1 285-1 prior to the AI agent-1 222-1 receiving the endpoint response and processes the endpoint response in an effort to verify 514 the endpoint response and determines, in this example, that the endpoint response is not received within a predetermined time (e.g., 5 seconds, 30 seconds, 1 minute, etc.) or is inaccurate (e.g., is not responsive to the agent request, includes a hallucination, etc.). Upon determining that the endpoint response is not received within a predetermined time (e.g., 5 seconds, 30 seconds, 1 minute, etc.) or is inaccurate, the observability layer 112 constrains 516 the endpoint, for example by terminating the endpoint, and generates an error message indicating that the endpoint is unavailable. Like the other error messages discussed herein, the error message follows the schema of the endpoint so that it is received by the AI agent as if sent from the endpoint, thereby keeping the observability layer invisible from the perspective of the AI agent. The error message is sent from the observability layer 112 to the AI agent-1 222-1. The AI agent-1 222-1, in response to receiving the error message and endpoint-1 285-1 being constrained, generates 519 and sends 520 a second agent request for an endpoint-2 285-2. The second agent request is received by the observability layer 112 prior to the endpoint-2 285-2 receiving the second agent request. The observability layer 112 then processes the second agent request and, in this example, verifies 522 that the second agent request is accurate (e.g., is not repetitive, follows the schema and protocol of the endpoint-2, does not include a hallucination, etc.). Upon verifying that the second agent request is accurate, the observability layer 112 passes 524 the second agent request to the endpoint-2 285-2. The endpoint-2 285-2 processes 525 the second agent request to produce and send 526 an endpoint-2 response.

The observability layer 112 receives the endpoint-2 response sent by the endpoint-2 285-2 prior to the AI agent-1 222-1 receiving the endpoint-2 response and processes the endpoint-2 response to verify 528 that the endpoint-2 response is accurate. Upon verifying that the endpoint-2 response is accurate, the observability layer 112 passes 530 the endpoint response to the AI agent-1 222-1.

In some implementations, upon determining that an endpoint response is not received within a predetermined time (e.g., 5 seconds, 30 seconds, 1 minute, etc.) or is inaccurate, rather than sending an error message back to the AI agent, as discussed above, the observability layer 112 may proactively determine a second endpoint, such as endpoint-2 285-2, that provides the same or similar functionality as the endpoint-1 285-1 and pass the agent request as the second agent request to the endpoint-2 285-2 without providing any notification/error message back to the AI agent-1 222-1. In such a configuration, the observability layer 112 determines the endpoint-2 285-2, sends the agent request as the second agent request, and manages the endpoint-2 response back from the endpoint-2 285-2 so that the endpoint-2 response is properly processed and returned to the AI agent-1 222-1 as responsive to the agent request originally sent from the AI agent-1222-1. For example, if the endpoint-2 285-2 follows a different schema than endpoint-1 285-1, the observability layer, as part of passing the agent request as the second agent request to the endpoint-2 285-2, may reconfigure the second agent request to conform to the schema of the endpoint-2 285-2. When the endpoint-2 response is received and processed to determine the endpoint-2 response is accurate, the observability layer may also reconfigure the endpoint-2 response to conform to the schema of the endpoint-1 285-1 so that, from the perspective of the AI agent-1 222-1, the endpoint-2 response passed back to the AI agent by the observability layer appears to have been sent by endpoint-1 285-1. In some implementations, the ability to automatically reassign tasks/requests without being detected by the requestor (e.g., AI agent-1 222-1 in the above example) is especially advantages when an endpoint or sub-agent, for example, needs to go offline for various reasons (e.g., maintenance or change to a new version). This allows the agentic workflow to continue without triggering any alarm that may cause one or more AI agents to waste computing resources on an event that can be easily solved. For example, wasting token to enter state tracker log to memorize that a request has been routed or wasting token to relay switching of sub-agent/endpoint to other AI agents in the agentic network.

The AI agent-1 222-1, upon receipt of the endpoint-2 response, generates 532 an agent response based at least in part on the endpoint-2 response. The AI agent-1222-1 then sends 534 the agent response, which is received by the observability layer 112 prior to the primary requester receiving the agent response. In some examples, if the AI agent sent out multiple agent requests, the AI agent may wait until all necessary endpoint responses are received prior to the AI agent generating and sending the agent response.

The observability layer 112, upon receipt of the agent response, processes the agent response to verify 536 that the agent response is accurate. Upon verifying that the agent response is accurate, the observability layer 112 sends 538 the agent response to the primary requester 205 as responsive to the primary request.

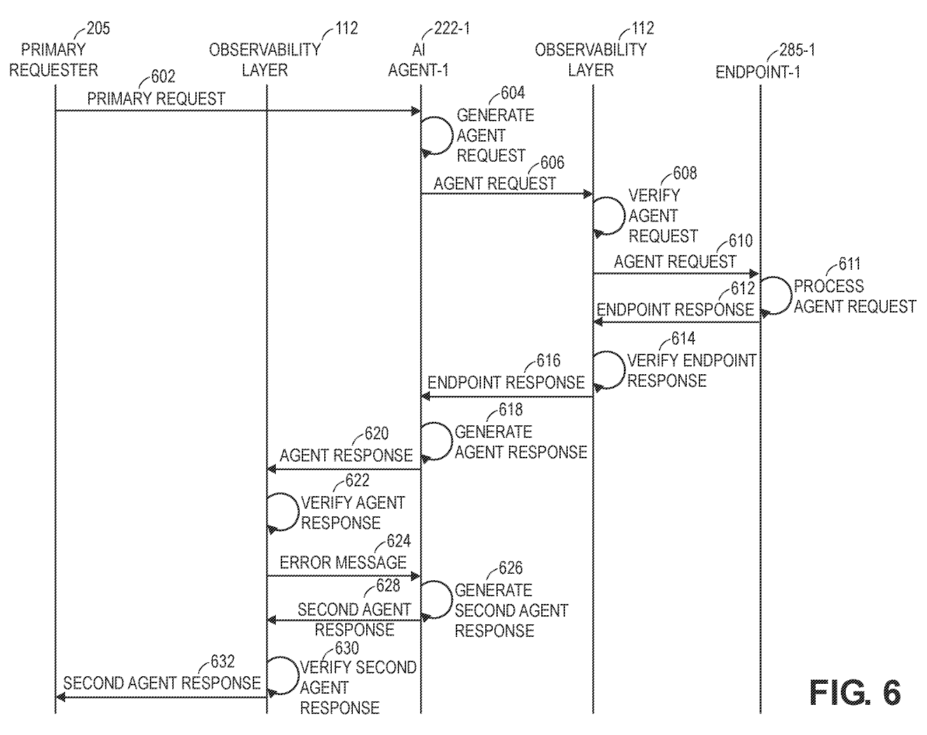

FIG. 6 illustrates a transition diagram in which the first agent response to the primary requester is not verified. Initially, the primary requester 205 sends a primary request 602 to AI agent-1 222-1 and the AI agent-1 222-1 generates 604 an agent request for an endpoint. The agent request is sent 606 from the AI agent-1 222-1 and received by the observability layer 112 prior to the endpoint-1 285-1 receiving the agent request. The observability layer 112 then processes the agent request and, in this example, verifies 608 that the agent request is accurate (e.g., is not repetitive, follows the schema and protocol of the endpoint, does not include a hallucination, etc.). Upon verifying that the agent request is accurate, the observability layer 112 passes 610 the agent request to the endpoint-1 285-1. The endpoint-1 285-1 processes 611 the agent request to produce and send 612 an endpoint response.

The observability layer 112 receives the endpoint response sent by the endpoint-1 285-1 prior to the AI agent-1 222-1 receiving the endpoint response and processes the endpoint response to verify 614 that the endpoint response is accurate (e.g., is responsive to the agent request, does not include a hallucination, etc.). Upon verifying that the endpoint response is accurate, the observability layer 112 passes 616 the endpoint response to the AI agent-1 222-1.

The AI agent-1 222-1, upon receipt of the endpoint response, generates 618 an agent response based at least in part on the endpoint response. The AI agent-1222-1 then sends 620 the agent response, which is received by the observability layer 112 prior to the primary requester receiving the agent response. The observability layer 112, upon receipt of the agent response, processes the agent response in an effort to verify 622 that the agent response is accurate. In this example, the observability layer 112 determines that the agent response is inaccurate. For example, the observability layer may determine that the agent response includes a hallucination. Alternatively, or additionally, the observability layer may determine that the agent response cannot be verified because it is not responsive to the primary request.

The observability layer 112, in response to determining that the agent response is inaccurate, generates and sends 624 an error message back to the AI agent-1222-1 indicating that either/both the agent response included a hallucination and/or that the agent response is not responsive to the primary request. If the primary requester 205 is another computing system, such as another agent, the error message may be generated according to the schema of the primary requester so that the error message appears to have been generated by the primary requester. As another example, if the primary requester is a user, the error message may be generated to reflect a response that may be generated by the user. The AI agent-1 222-1, upon receipt of the error message, performs self-reflection, generates 626 a second agent response to resolve the error message, and sends 628 the second agent response.

The second agent response is received by the observability layer 112 and processed to verify 630 that the second agent response is accurate (e.g., does not include a hallucination, is responsive to the primary request, etc.). Upon verifying that the second agent response is accurate, the observability layer 112 passes 632 the second agent response to the primary requester 205 as responsive to the primary request.

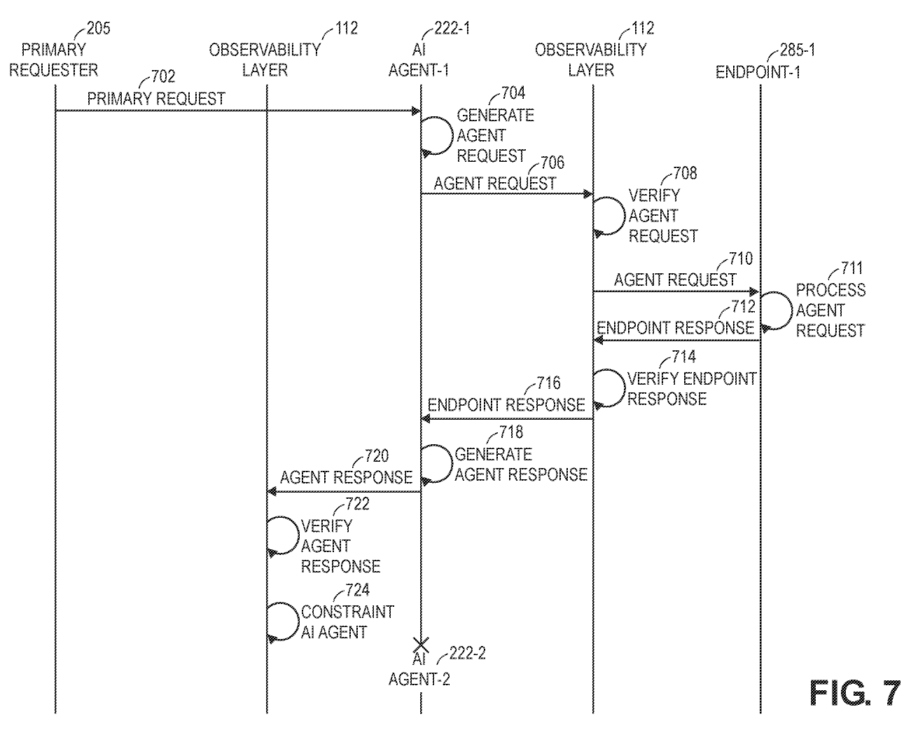

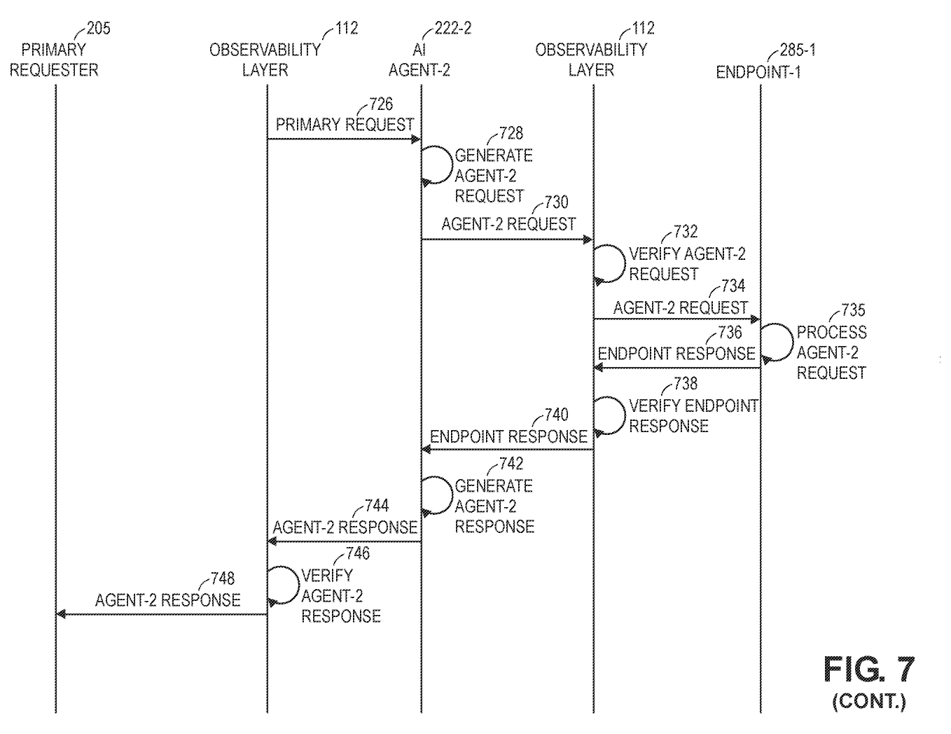

FIG. 7 illustrates another transition diagram in which the first agent response to the primary requester is not verified. Initially, the primary requester 205 sends a primary request 702 to AI agent-1 222-1 and the AI agent-1 222-1 generates 704 an agent request for an endpoint. The agent request is sent 706 from the AI agent-1 222-1 and received by the observability layer 112 prior to the endpoint-1 285-1 receiving the agent request. The observability layer 112 then processes the agent request and, in this example, verifies 708 that the agent request is accurate (e.g., not repetitive, follows the schema and protocol of the endpoint, does not include a hallucination, etc.). Upon verifying that the agent request is accurate, the observability layer 112 passes 710 the agent request to the endpoint-1 285-1. The endpoint-1 285-1 processes 711 the agent request to produce and send 712 an endpoint response.

The observability layer 112 receives the endpoint response sent by the endpoint-1 285-1 prior to the AI agent-1 222-1 receiving the endpoint response and processes the endpoint response to verify 714 that the endpoint response is accurate. Upon verifying that the endpoint response is accurate, the observability layer 112 passes 716 the endpoint response to the AI agent-1 222-1.

The AI agent-1 222-1, upon receipt of the endpoint response, generates 718 an agent response based at least in part on the endpoint response. The AI agent-1222-1 then sends 720 the agent response, which is received by the observability layer 112 prior to the primary requester receiving the agent response. The observability layer 112, upon receipt of the agent response, processes the agent response in an effort to verify 722 that the agent response is accurate (e.g., does not include a hallucination, is responsive to the primary request, etc.). In this example, the observability layer 112 determines that the agent response is inaccurate. For example, the observability layer may determine that the agent response includes a hallucination. Alternatively, or additionally, the observability layer may determine that the agent response cannot be verified because it is not responsive to the primary request.

In contrast to the example discussed with respect to FIG. 6, in this example, the observability later 112 determines 724 to constrain AI agent-1 222-1 (e.g., isolate, terminate, restart, etc.). In addition to constraining AI agent-1 222-1, the observability layer 112 sends 726 the primary request to AI agent-2 222-2 and the AI agent-2 222-2 generates 728 an agent-2 request for an endpoint. The agent request-2 is sent 730 from the AI agent-2 222-2 and received by the observability layer 112 prior to the endpoint-1 285-1 receiving the agent-2 request. The observability layer 112 then processes the agent-2 request and, in this example, verifies 732 that the agent-2 request is accurate. Upon verifying that the agent-2 request is accurate, the observability layer 112 passes 734 the agent-2 request to the endpoint-1 285-1. The endpoint-1 285-1 processes 735 the agent-2 request to produce and send 736 an endpoint response.

The observability layer 112 receives the endpoint response sent by the endpoint-1 285-1 prior to the AI agent-2 222-2 receiving the endpoint response and processes the endpoint response to verify 738 that the endpoint response is accurate. Upon verifying that the endpoint response is responsive to the agent-2 request, the observability layer 112 passes 740 the endpoint response to the AI agent-2 222-2.

The AI agent-2 222-2, upon receipt of the endpoint response, generates 742 an agent-2 response based at least in part on the endpoint response. The AI agent-2222-2 then sends 744 the agent-2 response, which is received by the observability layer 112 prior to the primary requester receiving the agent response. The observability layer 112, upon receipt of the agent-2 response, processes the agent-2 response to verify 746 that the agent-2 response is accurate. In this example, the observability layer 112 verifies that the agent-2 response is accurate. Upon verifying that the agent-2 response is accurate, the observability layer 112 passes 748 the agent-2 response to the primary requester 205 as responsive to the primary request. Similar to the discussion above regarding reassigning endpoint tasks in stealth, the ability to offline/switch an agent without impacting the overall communication flow of the agentic network enhances the overall stability of the network.

While the above examples discuss the observability layer verifying all requests and responses into and out of the AI agent, in some implementations, the observability layer may be configured to verify some but not all requests and/or responses. For example, the observability layer may be configured to only verify agent requests and agent responses generated by the agent but not verify endpoint responses received by the AI agent. Likewise, in some implementations, the disclosed implementations may be used with some but not all AI agents and/or some but not all endpoints. For example, users of the disclosed implementations may specify that the observability layer is to be used to verify requests and responses into and out of AI agents/endpoints related to finances but not for AI agents/endpoints related to shopping.

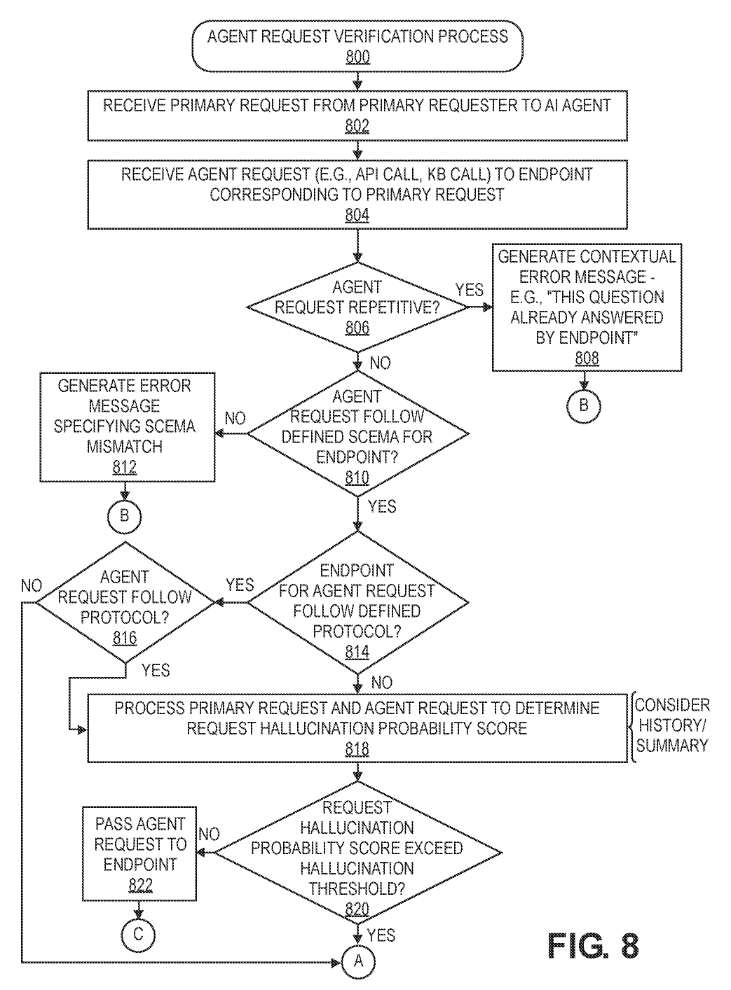

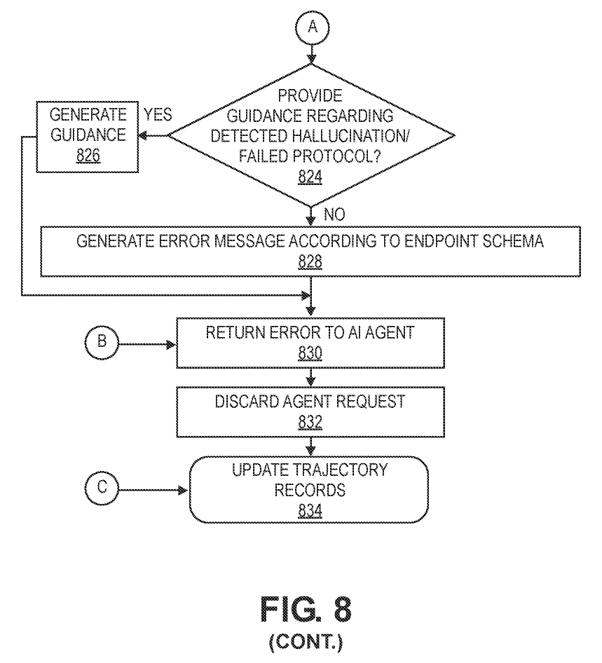

FIG. 8 is an example agent request verification process 800 performed by an observability layer 112, according to implementations of the present disclosure. The example process may be performed by the observability layer discussed herein.

The example process 800 begins upon receipt of a primary request from a primary requester to an AI agent, as in 802. The primary request may be any of a variety of requests for any of a variety of agents. For this example, we will use a request to tax support agent in which the user submits a primary request of “I need help calculating my taxes for last year.” As discussed above, the primary request is provided to an intended AI Agent.

After the primary request is provided to the intended AI agent, the observability layer receives an agent request to an endpoint from the AI agent that corresponds to the primary request, as in 804. The agent request may be, for example, an API call to an endpoint or a knowledge base query to a knowledge base.

The agent request verification component of the observability layer determines if the agent request is repetitive, as in 806. For example, the agent request verification component may obtain data from the state tracker and/or the trajectory records that show requests and responses from the agent to the endpoint and process that information to determine if the agent request is repetitive. If the agent request verification component determines that the agent request is repetitive, the agent request verification component generates a contextual error message (e.g., “this question already answered by endpoint”) indicating to the AI agent that the question is repetitive, as in 808.

If the agent request verification component determines that the agent request is not repetitive, the agent request verification component determines if the agent request follows a defined schema for the endpoint, as in 810. For example, if the agent request is an API call to an endpoint, the agent request verification component processes the API call to verify that it follows the rules and requirements specified in the API for that endpoint. If the agent request verification component determines that the agent request does not follow the defined schema for the endpoint, the agent request verification component generates an error message indicating the schema mismatch, as in 812.

If the agent request verification component determines that the agent request follows the defined schema for the endpoint, the agent request verification component may determine if the endpoint for the agent request follows a defined protocol, as in 814. For example, some endpoints require an order specifying an order in which different agent requests are to be sent to the endpoint. For example, if the endpoint is a hotel booking agent, the endpoint may require a protocol that an agent request be sent to the endpoint to determine if a room at a specific hotel is available on a specific day(s) before an agent request to reserve the room is sent to the endpoint. If the agent request verification component determines that the endpoint for the agent request follows a defined protocol, the agent request verification component determines if the agent request follows the protocol, as in 816. In some implementations, the agent request verification component may obtain summary data from the state tracker and/or historical data from the trajectory records and utilize that information to determine if the agent request follows the protocol for the endpoint.

In some implementations, one, some, or all of determining if the agent request is repetitive, determining if the agent request follows a defined schema for an endpoint, and determining if the agent request follows a defined protocol for the endpoint may be determined using one or more rule based agent request verification component(s). In other implementations, the agent request verification component may include a neural network configured to, for example, receive as inputs the agent request and the defined schema for endpoint and produce, as an output, a compliance score indicating if the agent request complies with the defined schema of the endpoint.

If the agent request verification component determines that the endpoint of the agent request does not follow a defined protocol (814) or if it is determined that the agent request follows the defined protocol (816) of the endpoint, the agent request verification component processes the primary request and the agent request to determine a request hallucination probability score indicative of a probability that the agent request includes a hallucination, as in 818. In some implementations, summary information from the state tracker and/or historical data from the trajectory records may also be considered when generating the request hallucination probability score for the agent request. For example, the agent request verification component may include a neural network configured to receive as inputs the primary request, the agent request to the endpoint, and any other information known to the observability layer regarding the primary request and/or the primary requester (e.g., historical data, user data, session data, other endpoint responses, etc.). The neural network may be trained to process the inputs and generate, as an output, a probability score indicative of a probability that the agent request includes a hallucination that is not factually supported by the other inputs received into the neural network.

For example and considering the primary input mentioned above of “I need help calculating my taxes for last year,” the agent request generated by the AI agent may follow a schema for an endpoint that is to provide tax related information for the user. The AI agent may generate an agent response that includes, for example, “user name is John Stone, user ID is 1111-22-3333, and he needs to file tax returns for 2024.” Such information in the agent request must be accurate and grounded in information already known about the user or communicated by the user. Accordingly, if the UserID is not already known and not provided in the primary request, the neural network of the agent request verification component will generate a high request hallucination probability score indicating a high probability that the agent request includes a hallucination – the UserID. In comparison, if all of the information indicated in the agent request is already known or included in the primary request, the neural network of the agent request verification component will output a low request hallucination probability score indicating a low probability that the agent request includes a hallucination.

The agent request verification component then determines if the output request hallucination probability score exceeds a hallucination threshold, as in 820. As discussed above, the hallucination threshold may be different for different agents, different for different primary requesters, etc., and is a metric to determine, based on the output request hallucination probability score whether an agent request includes a hallucination. If the agent request verification component determines that the request hallucination probability score does not exceed the hallucination threshold, the agent request is passed to the endpoint, as in 822. If the agent request verification component determines that the request hallucination probability score exceeds the hallucination threshold (820) or if it is determined that the agent request did not follow a defined protocol for the endpoint (816), a determination is made as to whether guidance is to be provided regarding the detected hallucination or if guidance is to be provided for a determination that the agent request is not following a protocol, as in 824.

If the agent request verification component determines that guidance is to be provided, guidance regarding the determined hallucination or the failed protocol is generated that indicates the aspect of the request that is determined to include a hallucination or indicates what portion of the defined protocol was not followed, as in 826. If the agent request verification component determines that guidance is not to be provided, the agent request verification component generates an error message corresponding to the determined hallucination and/or the determined endpoint protocol failure, as in 828. As discussed, the error message may be generated according to the schema of the endpoint so that the observability layer remains invisible to the AI agent. The agent request verification component then sends the generated error message (808, 812, 824) to the AI agent, as in 830. The agent request verification component also discards or otherwise refrains from sending the agent request to the endpoint, as in 832. Finally, after either passing the agent request to the endpoint (822) or after discarding the agent request (832), the trajectory records are updated to reflect the determinations made as part of the example process 800, as in 834.

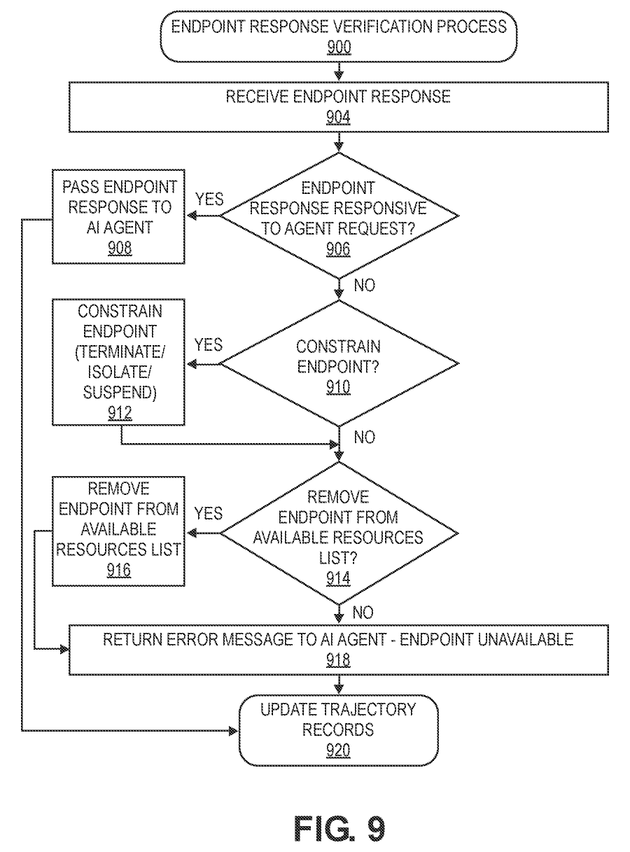

FIG. 9 is an example endpoint response verification process 900 performed by an observability layer, according to implementations of the present disclosure.

The example process 900 begins upon receipt at the observability layer of an endpoint response to an agent request, as in 904. The observability layer receives the endpoint response before the endpoint response is received at the AI agent. As discussed above, an endpoint generates and returns an endpoint response in reply to receiving an agent request. The endpoint response verification component of the observability layer then determines if the endpoint response is responsive to the agent request that was sent to the endpoint, as in 906. In some implementations, the agent request may be obtained from the state tracker and/or from the trajectory records. In other examples, the agent request may be maintained by the observability layer after it passes the agent request to the endpoint while it awaits the endpoint response.

In some implementations, the agent request and the endpoint response may be provided as inputs to a neural network that is trained to receive, as inputs, an agent request and an endpoint response and provide, as an output, a score indicative of whether the endpoint response is responsive to the agent request. In other implementations, the neural network may output a binary indicator indicating whether the endpoint response is responsive to the agent request or whether the endpoint response is not responsive to the agent request.

If the endpoint response verification component determines that the endpoint response is responsive to the agent request, the endpoint response verification component passes the endpoint response to the AI agent, as in 908. If the endpoint response verification component determines that the endpoint response is not responsive to the agent request, the endpoint response verification component determines if the endpoint is to be constrained (e.g., isolated, terminated, suspended, restarted, etc.), as in 910. If the endpoint response verification component determines to constrain the endpoint, the endpoint is constrained, as in 912. After constraining the endpoint (912) or if the endpoint response verification component determines to not constrain the endpoint (910), the endpoint response verification component determines if the endpoint is to be removed from an available resources list, as in 914. The available resources list indicates to AI agents resources (e.g., endpoints) that are available to the AI agents.

If the endpoint response verification component determines that the endpoint is to be removed from the available resources list, the endpoint response verification component removes the endpoint from the available resources list, as in 916. After removing the endpoint from the available resources list (916), or the endpoint response verification component determines that the endpoint is not to be removed from the available resources list (914), the endpoint response verification component generates and sends an error message to the AI agent indicating that the endpoint is unavailable, as in 918.

In some implementations, upon determining that an endpoint response is not received within a predetermined time (e.g., 5 seconds, 30 seconds, 1 minute, etc.) or is inaccurate, rather than sending an error message back to the AI agent indicating that the endpoint is unavailable (918), the endpoint response verification component and/or another component of the observability layer 112 may proactively determine a second endpoint that provides the same or similar functionality as the endpoint to which the agent response was originally sent and pass the agent request as a second agent request to the second endpoint without providing any notification/error message back to the AI agent. In such an implementation, the second verification component and/or other component of the observability layer determines the second endpoint, sends the agent request as the second agent request, and manages the second endpoint response back from the second endpoint so that the second endpoint response is properly processed and returned to the AI agent as responsive to the agent request originally sent from the AI agent. For example, if the second endpoint follows a different schema than the endpoint to which the agent request was originally sent, the second verification component and/or another component of the observability layer, as part of passing the agent request as the second agent request to the second endpoint, may reconfigure the second agent request to conform to the schema of the second endpoint. When the second endpoint response is received and processed to determine the second endpoint response is accurate (as part of the example process 900), the second verification component and/or another component of the observability layer may also reconfigure the second endpoint response to conform to the schema of the endpoint to which the agent request was originally sent so that, from the perspective of the AI agent, the endpoint response passed to the AI agent appears to have been sent by the original endpoint.

Finally, the trajectory records are updated to reflect the determinations made as part of the example process 900, as in 920.

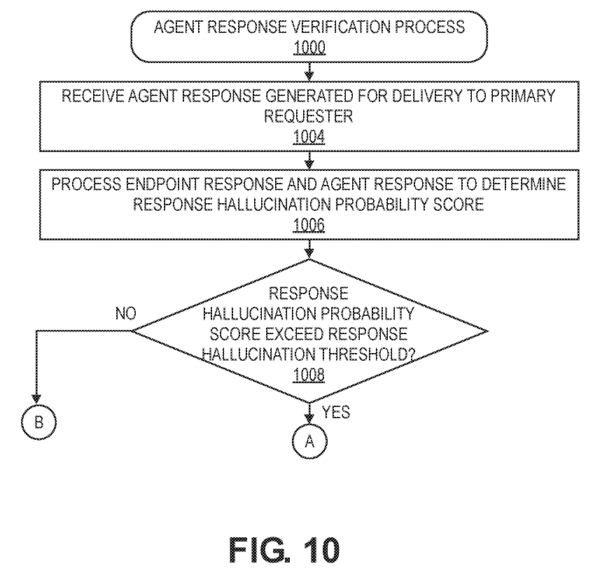

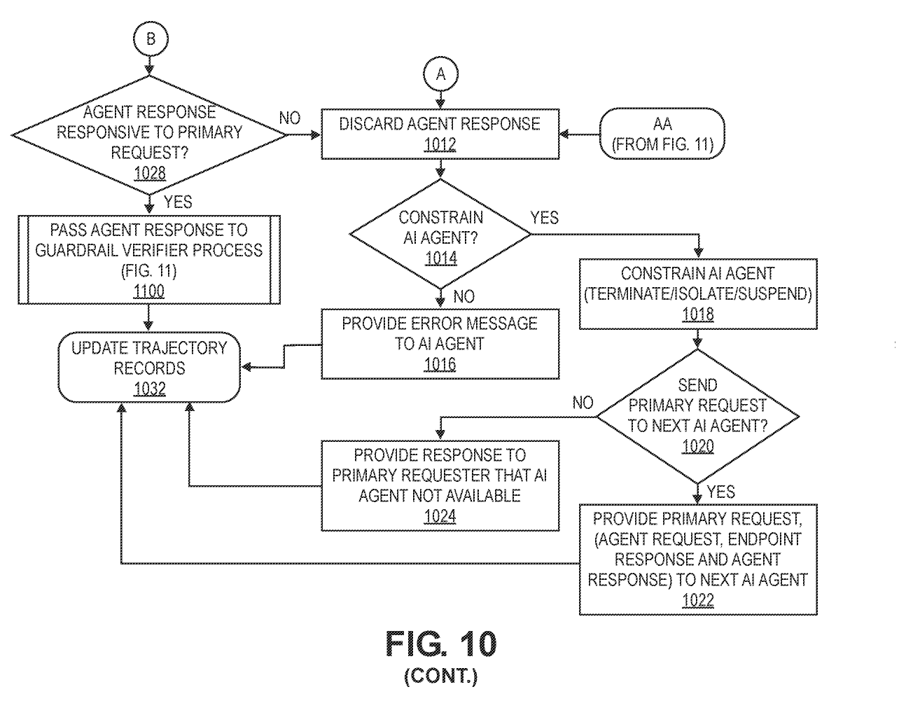

FIG. 10 is an example agent response verification process 1000 performed by an observability layer, according to implementations of the present disclosure.

The example process 1000 begins with the agent response verification component of the observability layer receiving an agent response generated for delivery to the primary requester in response to the primary request, as in 1004. The agent response is received by the agent response verification component before the agent response is received by the primary requester. The agent response verification component then processes the endpoint response and the agent response to determine a response hallucination probability score indicative of a probability that the agent response includes a hallucination, as in 1006. In some implementations, summary information from the state tracker and/or historical data from the trajectory records may also be considered when generating the response hallucination probability score for the agent response. For example, the agent response verification component may include a neural network configured to receive as inputs the endpoint response, the agent response, and any other information known to the observability layer regarding the primary request, the primary requester, the agent request, etc., (e.g., historical data, user data, session data, etc.). The neural network may be trained to process the inputs and generate, as an output, a response hallucination probability score indicative of a probability that the agent response includes a hallucination that is not factually supported by the other inputs received into the neural network.

For example if the endpoint response to an AI agent regarding a loan application states that the “loan application is pending approval” and the agent response states “Congratulations, you loan has been approved,” the agent response verification component may produce a high response hallucination probability score indicating a high probability that the agent response includes a hallucination that is not supported by the endpoint response.

The agent response verification component then determines if the output response hallucination probability score exceeds a response hallucination threshold, as in 1008. As discussed above, the response hallucination threshold may be different for different agents, different for different primary requesters, etc., and is a metric to determine, based on the output response hallucination probability score whether an agent response includes a hallucination. If the agent response verification component determines that the response hallucination probability score does not exceed the response hallucination threshold, a determination is made as to whether the agent response is responsive to the primary request, as in 1028. In some implementations, the primary request may be obtained from the state tracker and/or from the trajectory records. In other examples, the primary request may be maintained by the observability layer as it awaits the agent response.

In some implementations, the agent response and the primary request may be provided as inputs to a neural network that is trained to receive, as inputs, an agent response and the primary request and provide, as an output, a score indicative of whether the agent response is responsive to the primary request. In other implementations, the neural network may output a binary indicator indicating whether the agent response is responsive to the primary request or whether the agent response is not responsive to the primary request.

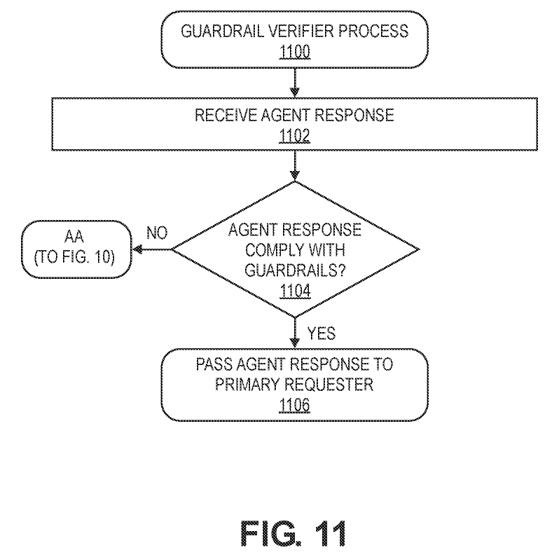

If the agent response verification component determines that the agent response is responsive to the primary request, the agent response verification component passes the agent response to the guardrail verifier process 1100 (FIG. 11). The guardrail verifier process 1100 is discussed further below with respect to FIG. 11.

If the agent response verification component determines that the agent response is not responsive to the primary request (1028) or if the agent response verification component determines that the response hallucination probability score exceeds the response hallucination threshold (1008), the agent response verification component discards the agent response, as in 1012. Additionally, the agent response verification component may determine if the AI agent is to be constrained (e.g., isolated, terminated, suspended, restarted, etc.), as in 1014. If the agent response verification component determines not to constrain the agent, the agent response verification component generates and sends to the AI agent an error message indicating that the agent response is at least one of not responsive to the primary request or included a hallucination, as in 1016. As with the other error messages generated by the observability layer, the error message may be generated according to the schema of the primary requester so that observability layer remains invisible to the AI agent.

If the agent response verification component determines to constrain the agent, the agent is constrained, as in 1018. In addition to constraining the agent, the agent response verification component may also determine if the primary request is to be sent to a next AI agent that provides a same/similar function as the now constrained AI agent, as in 1020. If the agent response verification component determines to not send the primary request to a next AI agent, the agent response verification component generates and sends back to the primary requester a notification that the AI agent is unavailable, as in 1024. In other examples, the primary response, and optionally the agent response and/or endpoint response may be sent to a human for review, adjustment, and possibly generation of a response that is sent back to the primary requester. If the agent response generation component determines to send the primary request to a next AI agent, the primary request and optionally the agent request, endpoint response, and/or agent response, are sent to a next AI agent, as in 1022.

In addition to providing the error message to the AI agent (1016), providing a response to the primary requester that the AI agent is unavailable (1024), or after providing the primary request to a next AI agent (1022), the trajectory records are updated to reflect the determinations made as part of the example process 1000, as in 1032.

FIG. 11 is an example guardrail verifier process 1100 performed by an observability layer, according to implementations of the present disclosure.

The guardrail verifier process 1100 may be initiated by the example process 1000, as discussed above, upon determination that an agent response does not include a hallucination and is responsive to a primary request. In particular, the agent response approved by the example process 1000 may be received by the example process 1100, as in 1102. Upon receipt of the agent response, the observability layer determines if the agent response complies with one or more guardrails, as in 1104. Guardrails may be any guidelines and/or rules specified by an agent or other entity that must be followed when generating an agent response. Guardrails may vary for different AI agents, different primary requesters, etc. Example guardrails that may be considered by the example process 1100 include, but are not limited to, proper citations for any quotes or references to other documents, no foul language, no slang, etc.

If the observability layer determines that the agent response complies with the guardrails, the agent response is passed to the primary requester as responsive to the primary request, as in 1106. If the observability layer determines that the agent response does not comply with the guardrails, the example process 1100 returns to block 1012 (FIG. 10) and continues. In some implementations, even if the response does comply with the guardrails, if the action is, for example, to complete a purchase, make a reservation, or take some other form of action on behalf of the primary requester, the observability layer may confirm that an additional confirmation has been received from the primary requester before the action is performed.

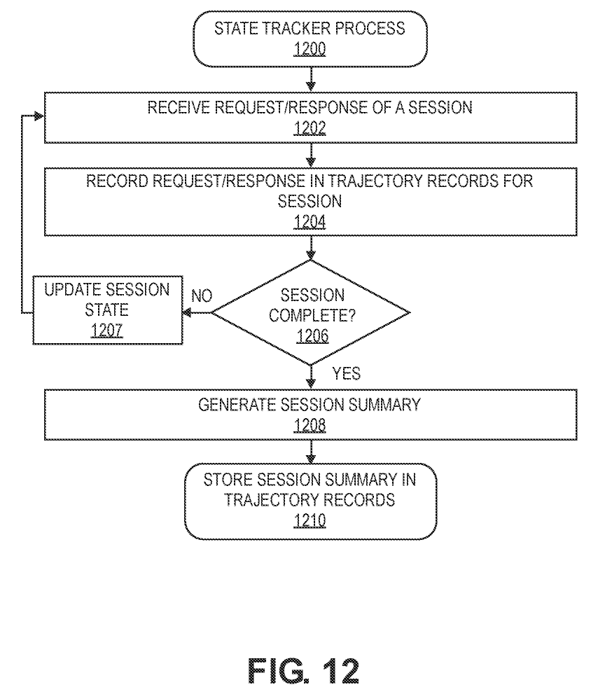

FIG. 12 is an example state tracker process 1200 performed by the state tracker 114 of the observability layer 112, according to implementations of the present disclosure. In particular, the example process 1200 may be performed by the state tracker 114 concurrent with operation of the other components of the observability layer discussed herein.

The example process 1200 begins upon receipt of a request or a response, such as a primary request, an agent request, an endpoint response, or an agent response, as in 1202. Upon receipt of a request or a response, the state tracker 114 records the request or response in the trajectory records 118 as part of a session to which the request or response corresponds, as in 1204. The state tracker may then determine if the session is complete, as in 1206. It may be determined that the session is complete if, for example, the recorded response is an agent response to a primary request, if the primary requester ends a session, logs off or disconnects from the provider network, after a defined time duration (e.g., 5 minutes) of no activity following an agent response to the primary requester, etc.

If the state tracker 114 determines that the session is not complete, the state tracker updates a state of the session based on the received request/response, as in 1207, and the example process 1200 returns to block 1202 and awaits receipt of the next request or response as part of the session. If the state tracker 114 determines that the session is complete, the state tracker 114 generates a session summary of the session, as in 1208. For example, the session summary may provide a summary of each set of requests and responses that occurred during the session, a summary of any errors generated by an agent or an endpoint during the session, a summary of any constraints of endpoints or agents as part of the session, etc. Finally, the state tracker 114 stores the session summary in the trajectory records, as in 1210.

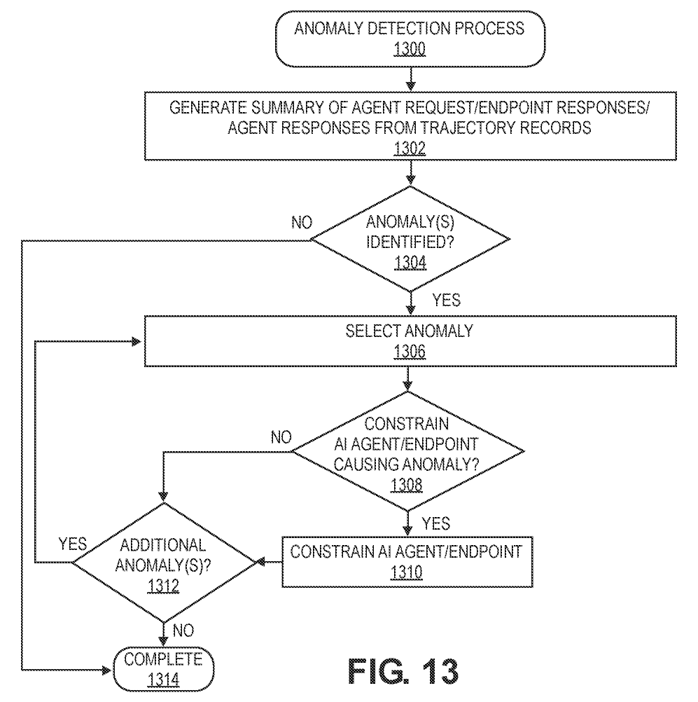

FIG. 13 is an example anomaly detection process 1300, according to implementations of the present disclosure. The example anomaly detection process 1300 may be periodically performed by the provider network and/or another component of the provider network to determine any anomalies that are not detected during a session. In some implementations, the example anomaly detection process is performed daily. In other implementations, the example process 1300 may be performed more or less frequently.

The example process begins by accessing the trajectory records and generating a summary of agent requests, endpoint responses, and/or agent responses over multiple sessions, as in 1302. In some examples the session summaries for multiple sessions maintained in the trajectory records may be aggregated to determine the summary of agent requests, endpoint responses, and/or agent responses over multiple sessions. In other implementations, the agent requests, endpoint responses, agent responses logged in the trajectory records by the state tracker may be processed. In still other examples, both the session summaries and the logged agent requests, endpoint responses, and agent responses may be utilized.

Summarizing of agent requests, endpoint responses, and/or agent responses over multiple sessions helps identify potential health issues (e.g., with endpoints and/or agents) and to identify anomalies that are difficult to detect on a session level basis. For example, if an agent is a booking agent and during a session the AI agent generates and sends endpoint requests to airlines, ferries, and taxis, but not to car rentals, nothing appears anomalous. However, if thousands of the AI agent’s sessions are summarized and the car rental endpoint is never called, it may be indicative of an anomaly with either the AI agent or the endpoint.

Based on the summary of agent requests, endpoint responses, and/or agent responses, a determination is made as to whether any anomalies exist, as in 1304. Anomalies may be determined based on analysis of the summary of the agent requests, endpoint responses, and/or agent response to determine anomalies or outliers in the data. For example, a count of the number of agent requests sent to a first endpoint and the number of inaccurate endpoint responses generated in return by the first endpoint may be analyzed to determine if an anomaly exists with respect to the first endpoint. For example, if the number of inaccurate endpoint responses produced by the first endpoint is more than two standard deviations from the mean of inaccurate responses produced by all endpoints, it may be determined that the number of inaccurate responses produced by an endpoint is an anomaly. While the examples discussed herein primarily focus on detecting anomalies around inaccurate responses (i.e., negative anomalies), the disclosed implementations and the example process 1300 may also detect positive anomalies. Positive anomalies include, for example, an agent that is able to self-recover in response to an error message more frequently than other agents.

Returning to FIG. 13, if it is determined at decision block 1304 that no anomalies are identified, the example process 1300 completes, as in 1314. If one or more anomalies are identified, an identified anomaly is selected as in 1306, and a determination made as to whether the AI agent or endpoint causing the anomaly should be constrained (e.g., isolated, terminated, suspended, restarted, etc.), as in 1308. In some implementations, identified negative anomalies may automatically result in the AI agent or endpoint causing the anomaly to be constrained and a notification sent to an operator to review and possibly adjust, restart, etc., the AI agent or endpoint to resolve the anomaly. In other examples, the anomaly from the AI agent or endpoint must be detected a defined number of times (e.g., three times) by the example process before the AI agent or endpoint is constrained. Comparatively, positive anomalies may never be constrained.

If it is determined to constrain the AI agent or endpoint causing the anomaly, the AI agent or endpoint is constrained, as in 1310. As discussed above, constraining of an AI agent or endpoint may include any one or more of isolating the AI agent/endpoint, terminating the AI agent/endpoint, suspending the AI agent/endpoint, restarting the AI agent/endpoint, etc. Additionally, an operator may be notified of the constraint to the AI agent/endpoint so the operator can take action in an effort to resolve the anomaly. Likewise, the constrained AI agent/endpoint may be removed from an availability list of AI agents/endpoints so that other AI agents/endpoints do not attempt to call, access, or otherwise utilize the constrained AI agent/endpoint.

After constraining the AI agent/endpoint (1310) or if it is determined at decision block 1308 that the AI agent/endpoint is not to be constrained, a determination is made as to whether there are additional anomalies identified by the example process 1300, as in 1312. If no additional anomalies are identified, the example process 1300 completes, as in 1314. If another anomaly was identified, the example process 1300 returns to block 1306, selects a next anomaly, and continues.

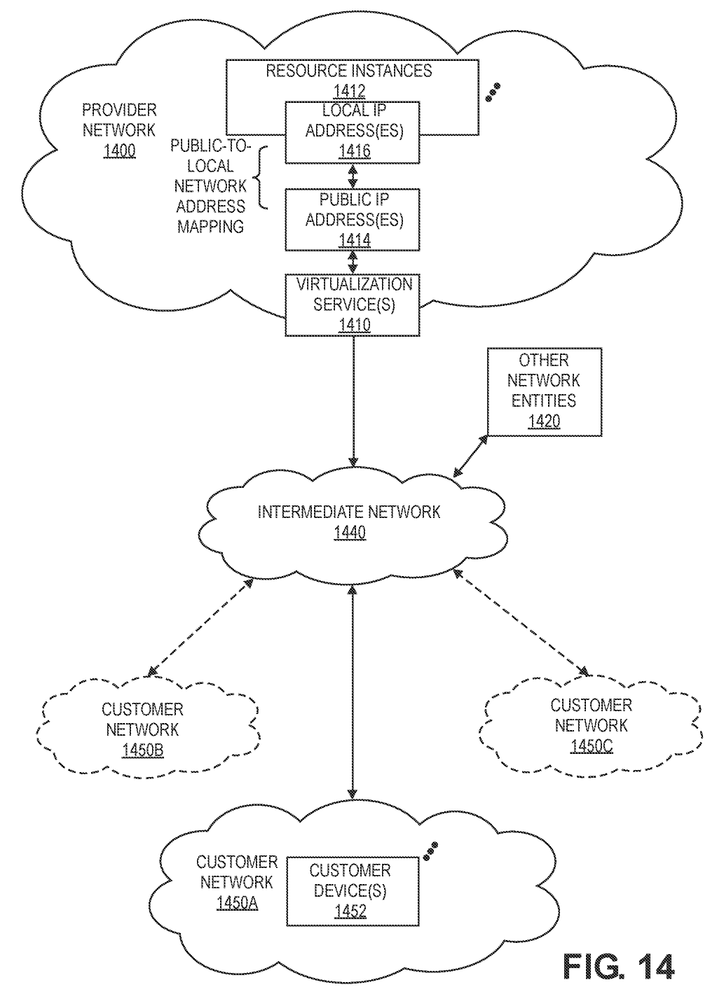

FIG. 14 illustrates an example provider network (or “service provider system”) environment according to some examples. A provider network 1400 can provide resource virtualization to customers via one or more virtualization services 1410 that allow customers to purchase, rent, or otherwise obtain resource instances 1412 of virtualized resources, including but not limited to computation and storage resources, implemented on devices within the provider network or networks in one or more data centers. Local Internet Protocol (IP) addresses 1416 can be associated with the resource instances 1412; the local IP addresses are the internal network addresses of the resource instances 1412 on the provider network 1400. In some examples, the provider network 1400 can also provide public IP addresses 1414 and/or public IP address ranges (e.g., Internet Protocol version 4 (IPv4) or Internet Protocol version 6 (IPv6) addresses) that customers can obtain from the provider network 1400.

Conventionally, the provider network 1400, via the virtualization services 1410, can allow a customer of the service provider (e.g., a customer that operates one or more customer networks 1450A, 1450B, through 1450C (or “client networks”) including one or more customer device(s) 1452) to dynamically associate at least some public IP addresses 1414 assigned or allocated to the customer with particular resource instances 1412 assigned to the customer. The provider network 1400 can also allow the customer to remap a public IP address 1414, previously mapped to one virtualized computing resource instance 1412 allocated to the customer, to another virtualized computing resource instance 1412 that is also allocated to the customer. Using the virtualized computing resource instances 1412 and public IP addresses 1414 provided by the service provider, a customer of the service provider such as the operator of the customer network(s) 1450A-1450C can, for example, implement customer-specific applications and present the customer’s applications on an intermediate network 1440, such as the Internet. Other network entities 1420 on the intermediate network 1440 can then generate traffic to a destination public IP address 1414 published by the customer network(s) 1450A-1450C; the traffic is routed to the service provider data center, and at the data center is routed, via a network substrate, to the local IP address 1416 of the virtualized computing resource instance 1412 currently mapped to the destination public IP address 1414. Similarly, response traffic from the virtualized computing resource instance 1412 can be routed via the network substrate back onto the intermediate network 1440 to the source entity 1420.

Local IP addresses, as used herein, refer to the internal or “private” network addresses, for example, of resource instances in a provider network. Local IP addresses can be within address blocks reserved by Internet Engineering Task Force (IETF) Request for Comments (RFC) 1918 and/or of an address format specified by IETF RFC 4193 and can be mutable within the provider network. Network traffic originating outside the provider network is not directly routed to local IP addresses; instead, the traffic uses public IP addresses that are mapped to the local IP addresses of the resource instances. The provider network can include networking devices or appliances that provide network address translation (NAT) or similar functionality to perform the mapping from public IP addresses to local IP addresses and vice versa.

Public IP addresses are Internet mutable network addresses that are assigned to resource instances, either by the service provider or by the customer. Traffic routed to a public IP address is translated, for example via 1:1 NAT, and forwarded to the respective local IP address of a resource instance.

Some public IP addresses can be assigned by the provider network infrastructure to particular resource instances; these public IP addresses can be referred to as standard public IP addresses, or simply standard IP addresses. In some examples, the mapping of a standard IP address to a local IP address of a resource instance is the default launch configuration for all resource instance types.

At least some public IP addresses can be allocated to or obtained by customers of the provider network 1400; a customer can then assign their allocated public IP addresses to particular resource instances allocated to the customer. These public IP addresses can be referred to as customer public IP addresses, or simply customer IP addresses. Instead of being assigned by the provider network 1400 to resource instances as in the case of standard IP addresses, customer IP addresses can be assigned to resource instances by the customers, for example via an API provided by the service provider. Unlike standard IP addresses, customer IP addresses are allocated to customer accounts and can be remapped to other resource instances by the respective customers as necessary or desired. A customer IP address is associated with a customer’s account, not a particular resource instance, and the customer controls that IP address until the customer chooses to release it. Unlike conventional static IP addresses, customer IP addresses allow the customer to mask resource instance or availability zone failures by remapping the customer’s public IP addresses to any resource instance associated with the customer’s account. The customer IP addresses, for example, enable a customer to engineer around problems with the customer’s resource instances or software by remapping customer IP addresses to replacement resource instances.

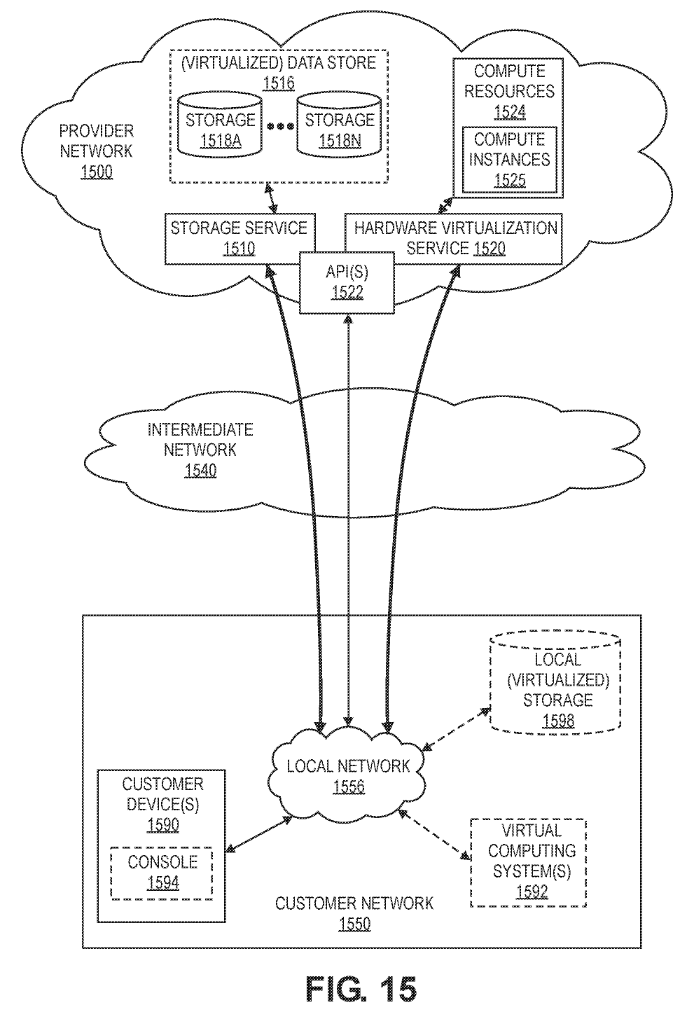

FIG. 15 is a block diagram of an example provider network environment 1500 that provides a storage service and a hardware virtualization service to customers, according to some examples. A hardware virtualization service 1520 provides multiple compute resources 1524 (e.g., compute instances 1525, such as VMs) to customers. The compute resources 1524 can, for example, be provided as a service to customers of a provider network 1500 (e.g., to a customer that implements a customer network 1550). Each computation resource 1524 can be provided with one or more local IP addresses. The provider network 1500 can be configured to route packets from the local IP addresses of the compute resources 1524 to public Internet destinations, and from public Internet sources to the local IP addresses of the compute resources 1524.

The provider network 1500 can provide the customer network 1550, for example coupled to an intermediate network 1540 via a local network 1556, the ability to implement virtual computing systems 1592 via the hardware virtualization service 1520 coupled to the intermediate network 1540 and to the provider network 1500. In some examples, the hardware virtualization service 1520 can provide one or more APIs 1522, for example a web services interface, via which the customer network 1550 can access functionality provided by the hardware virtualization service 1520, for example via a console 1594 (e.g., a web-based application, standalone application, mobile application, etc.) of a customer device 1590. In some examples, at the provider network 1500, each virtual computing system 1592 at the customer network 1550 can correspond to a computation resource 1524 that is leased, rented, or otherwise provided to the customer network 1550.

From an instance of the virtual computing system(s) 1592 and/or another customer device 1590 (e.g., via console 1594), the customer can access the functionality of a storage service 1510, for example via the one or more APIs 1522, to access data from and store data to storage resources 1518A-1518N of a virtual data store 1516 (e.g., a folder or “bucket,” a virtualized volume, a database, etc.) provided by the provider network 1500. In some examples, a virtualized data store gateway (not shown) can be provided at the customer network 1550 that can locally cache at least some data, for example frequently accessed or critical data, and that can communicate with the storage service 1510 via one or more communications channels to upload new or modified data from a local cache so that the primary store of data (the virtualized data store 1516) is maintained. In some examples, a user, via the virtual computing system 1592 and/or another customer device 1590, can mount and access virtual data store 1516 volumes via the storage service 1510 acting as a storage virtualization service, and these volumes can appear to the user as local (virtualized) storage 1598.

While not shown in FIG. 15, the virtualization service(s) can also be accessed from resource instances within the provider network 1500 via the API(s) 1522. For example, a customer, appliance service provider, AI agent, or other entity can access a virtualization service from within a respective virtual network on the provider network 1500 via the API(s) 1522 to request allocation of one or more resource instances within the virtual network or within another virtual network.

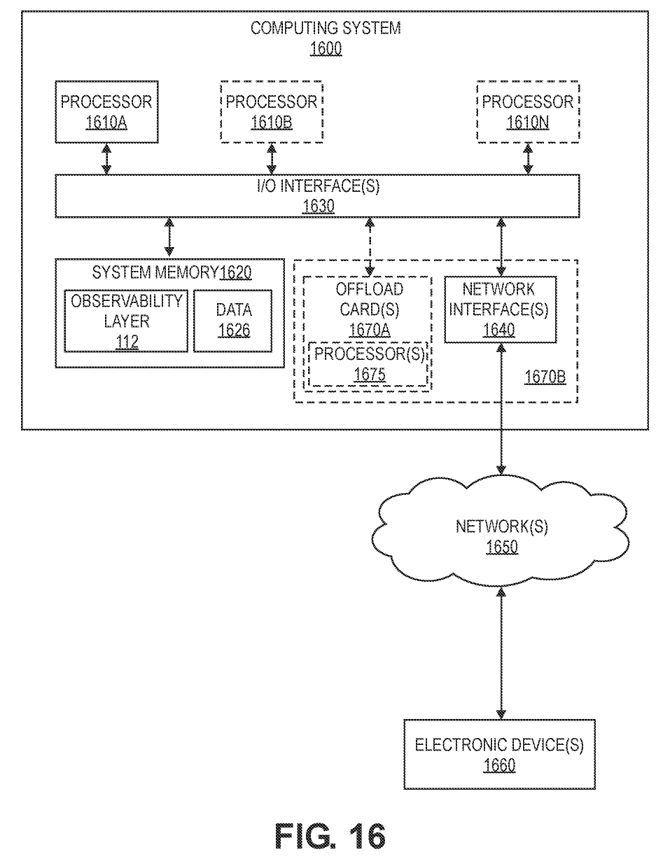

In some examples, a system that implements a portion or all of the techniques described herein can include a general-purpose computing system, such as the computing system 1600 (also referred to as a computing device or electronic device) illustrated in FIG. 16, that includes, or is configured to access, one or more computer-accessible media. In the illustrated example, the computing system 1600 includes one or more processors 1610A, 1610B, through 1610N coupled to a system memory 1620 via an input/output (I/O) interface 1630. The computing system 1600 further includes a network interface 1640 coupled to the I/O interface 1630. While FIG. 16 shows the computing system 1600 as a single computing device, in various examples the computing system 1600 can include one computing device or any number of computing devices configured to work together as a single computing system 1600.

In various examples, the computing system 1600 can be a uniprocessor system including one processor 1610A, or a multiprocessor system including several processors 1610A, 1610B, through 1610N (e.g., two, four, eight, or another suitable number). The processor(s) 1610A-1610N can be any suitable processor(s) capable of executing instructions. For example, in various examples, the processor(s) 1610 can be general-purpose or embedded processors implementing any of a variety of instruction set architectures (ISAs), such as the x86, ARM, PowerPC, SPARC, or MIPS ISAs, or any other suitable ISA. In multiprocessor systems, each of the processors 1610A, 1610B, through 1610N can commonly, but not necessarily, implement the same ISA.

The system memory 1620 can store instructions and data accessible by the processor(s) 1610. In various examples, the system memory 1620 can be implemented using any suitable memory technology, such as random-access memory (RAM), static RAM (SRAM), synchronous dynamic RAM (SDRAM), nonvolatile/Flash-type memory, or any other type of memory. In the illustrated example, program instructions and data implementing one or more desired functions, such as those methods, techniques, and data described above, are shown stored within the system memory 1620 as observability layer 112 (e.g., executable to implement, in whole or in part, the implementations described herein) and data 1626.

In some examples, the I/O interface 1630 can be configured to coordinate I/O traffic between the processor(s) 1610A-1610N, the system memory 1620, and any peripheral devices in the device, including the network interface 1640 and/or other peripheral interfaces (not shown). In some examples, the I/O interface 1630 can perform any necessary protocol, timing, or other data transformations to convert data signals from one component (e.g., the system memory 1620) into a format suitable for use by another component (e.g., the processor 1610A). In some examples, the I/O interface 1630 can include support for devices attached through various types of peripheral buses, such as a variant of the Peripheral Component Interconnect (PCI) bus standard or the Universal Serial Bus (USB) standard, for example. In some examples, the function of the I/O interface 1630 can be split into two or more separate components, such as a north bridge and a south bridge, for example. Also, in some examples, some or all of the functionality of the I/O interface 1630, such as an interface to the system memory 1620, can be incorporated directly into one or more of the processor(s) 1610A-1610N.

The network interface 1640 can be configured to allow data to be exchanged between the computing system 1600 and one or more other electronic devices 1660 attached to a network or networks 1650, such as other computing systems or devices as illustrated in FIGS. 1A-1B, for example. In various examples, the network interface 1640 can support communication via any suitable wired or wireless general data networks, such as types of Ethernet network, for example. Additionally, the network interface 1640 can support communication via telecommunications/telephony networks, such as analog voice networks or digital fiber communications networks, via storage area networks (SANs), such as Fibre Channel SANs, and/or via any other suitable type of network and/or protocol.

In some examples, the computing system 1600 includes one or more offload cards 1670A or 1670B (including one or more processors 1675, and possibly including the one or more network interfaces 1640) that are connected using the I/O interface 1630 (e.g., a bus implementing a version of the Peripheral Component Interconnect - Express (PCI-E) standard, or another interconnect such as a QuickPath interconnect (QPI) or UltraPath interconnect (UPI)). For example, in some examples the computing system 1600 can act as a host electronic device (e.g., operating as part of a hardware virtualization service) that hosts compute resources such as compute instances, and the one or more offload cards 1670A or 1670B execute a virtualization manager that can manage compute instances that execute on the host electronic device. As an example, in some examples the offload card(s) 1670A or 1670B can perform compute instance management operations, such as pausing and/or un-pausing compute instances, launching and/or terminating compute instances, performing memory transfer/copying operations, etc. These management operations can, in some examples, be performed by the offload card(s) 1670A or 1670B in coordination with a hypervisor (e.g., upon a request from a hypervisor) that is executed by the other processors 1610A-1610N of the computing system 1600. However, in some examples the virtualization manager implemented by the offload card(s) 1670A or 1670B can accommodate requests from other entities (e.g., from compute instances themselves), and cannot coordinate with (or service) any separate hypervisor.

In some examples, the system memory 1620 can be one example of a computer-accessible medium configured to store program instructions and data as described above. However, in other examples, program instructions and/or data can be received, sent, or stored upon different types of computer-accessible media. Generally speaking, a computer-accessible medium can include any non-transitory storage media or memory media such as magnetic or optical media, e.g., disk or DVD/CD coupled to the computing system 1600 via the I/O interface 1630. A non-transitory computer-accessible storage medium can also include any volatile or non-volatile media such as RAM (e.g., SDRAM, double data rate (DDR) SDRAM, SRAM, etc.), read only memory (ROM), etc., that can be included in some examples of the computing system 1600 as the system memory 1620 or another type of memory. Further, a computer-accessible medium can include transmission media or signals such as electrical, electromagnetic, or digital signals, conveyed via a communication medium such as a network and/or a wireless link, such as can be implemented via the network interface 1640.

Various examples discussed or suggested herein can be implemented in a wide variety of operating environments, which in some cases can include one or more user computers, computing devices, or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and/or other devices capable of communicating via a network.

Most examples use at least one network that would be familiar to those skilled in the art for supporting communications using any of a variety of widely available protocols, such as Transmission Control Protocol / Internet Protocol (TCP/IP), File Transfer Protocol (FTP), Universal Plug and Play (UPnP), Network File System (NFS), Common Internet File System (CIFS), Extensible Messaging and Presence Protocol (XMPP), AppleTalk, etc. The network(s) can include, for example, a local area network (LAN), a wide-area network (WAN), a virtual private network (VPN), the Internet, an intranet, an extranet, a public switched telephone network (PSTN), an infrared network, a wireless network, and any combination thereof.

In examples using a web server, the web server can run any of a variety of server or mid-tier applications, including HTTP servers, File Transfer Protocol (FTP) servers, Common Gateway Interface (CGI) servers, data servers, Java servers, business application servers, etc. The server(s) also can be capable of executing programs or scripts in response to requests from user devices, such as by executing one or more Web applications that can be implemented as one or more scripts or programs written in any programming language, such as Java®, C, C# or C++, or any scripting language, such as Perl, Python®, PHP, or TCL®, as well as combinations thereof. The server(s) can also include database servers, including without limitation those commercially available from Oracle®, Microsoft®, Sybase®, IBM®, etc. The database servers can be relational or non-relational (e.g., “NoSQL”), distributed or non-distributed, etc.

Environments disclosed herein can include a variety of data stores and other memory and storage media as discussed above. These can reside in a variety of locations, such as on a storage medium local to (and/or resident in) one or more of the computers or remote from any or all of the computers across the network. In a particular set of examples, the information can reside in a storage-area network (SAN) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad), and/or at least one output device (e.g., a display device, printer, or speaker). Such a system can also include one or more storage devices, such as disk drives, optical storage devices, and solid-state storage devices such as random-access memory (RAM) or read-only memory (ROM), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or web browser. It should be appreciated that alternate examples can have numerous variations from that described above. For example, customized hardware might also be used and/or particular elements might be implemented in hardware, software (including portable software, such as applets), or both. Further, connection to other computing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (EEPROM), flash memory or other memory technology, Compact Disc-Read Only Memory (CD-ROM), Digital Versatile Disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various examples.

In the preceding description, various examples are described. For purposes of explanation, specific configurations and details are set forth in order to provide a thorough understanding of the examples. However, it will also be apparent to one skilled in the art that the examples can be practiced without the specific details. Furthermore, well-known features can be omitted or simplified in order not to obscure the example being described.

Bracketed text and blocks with dashed borders (e.g., large dashes, small dashes, dot-dash, and dots) are used herein to illustrate optional aspects that add additional features to some examples. However, such notation should not be taken to mean that these are the only options or optional operations, and/or that blocks with solid borders are not optional in certain examples.

Reference numerals with suffix letters (e.g., 1518A-1518N) can be used to indicate that there can be one or multiple instances of the referenced entity in various examples, and when there are multiple instances, each does not need to be identical but may instead share some general traits or act in common ways. Further, the particular suffixes used are not meant to imply that a particular amount of the entity exists unless specifically indicated to the contrary. Thus, two entities using the same or different suffix letters might or might not have the same number of instances in various examples.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” is intended to be understood to mean either A, B, or C, or any combination thereof (e.g., A, B, and/or C). Similarly, language such as “at least one or more of A, B, and C” (or “one or more of A, B, and C”) is intended to be understood to mean A, B, or C, or any combination thereof (e.g., A, B, and/or C). As such, disjunctive language is not intended to, nor should it be understood to, imply that a given example requires at least one of A, at least one of B, and at least one of C to each be present.

As used herein, the term “based on” (or similar) is an open-ended term used to describe one or more factors that affect a determination or other action. It is to be understood that this term does not foreclose additional factors that may affect a determination or action. For example, a determination may be solely based on the factor(s) listed or based on the factor(s) and one or more additional factors. Thus, if an action A is “based on” B, it is to be understood that B is one factor that affects action A, but this does not foreclose the action from also being based on one or multiple other factors, such as factor C. However, in some instances, action A may be based entirely on B.

Unless otherwise explicitly stated, articles such as “a” or “an” should generally be interpreted to include one or multiple described items. Accordingly, phrases such as “a device configured to” or “a computing device” are intended to include one or multiple recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C.

Further, the words “may” or “can” are used in a permissive sense (i.e., meaning having the potential to), rather than the mandatory sense (i.e., meaning must). The words “include,” “including,” and “includes” are used to indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for the nouns that they precede, and do not imply any type of ordering (e.g., spatial, temporal, logical, etc.) unless such an ordering is otherwise explicitly indicated. Similarly, the values of such numeric labels are generally not used to indicate a required amount of a particular noun in the claims recited herein, and thus a “fifth” element generally does not imply the existence of four other elements unless those elements are explicitly included in the claim or it is otherwise made abundantly clear that they exist.

The specification and drawings are, accordingly, to be regarded in an illustrative rather than a restrictive sense. It will, however, be evident that various modifications and changes can be made thereunto without departing from the broader scope of the disclosure as set forth in the claims.

What is claimed is:

1. A computer-implemented method performed by an observability layer such that the observability layer remains hidden to one or more artificial intelligence (“AI”) agents of an agentic network, the computer-implemented method comprising:
receiving, at the observability layer and from an AI agent of the one or more AI agents of the agentic network, an agent request to an endpoint prior to the endpoint receiving the agent request;
processing, at the observability layer, the agent request to determine that the agent request is accurate;
in response to determining that the agent request is accurate, passing, from the observability layer, the agent request to the endpoint;
receiving, at the observability layer and from the AI agent, an agent response to a primary requester prior to the primary requester receiving the agent response;
processing, at the observability layer, the agent response and an endpoint response generated by the endpoint in response to the agent request, to determine that the agent response is inaccurate;
in response to determining that the agent response is inaccurate, sending, from the observability layer, a message to the AI agent that conforms to a schema of the primary requester such that the message appears to be sent to the AI agent by the primary requester, the message indicating that the agent response is inaccurate;
receiving, at the observability layer and from the AI agent, a second agent response to the primary requester prior to the primary requester receiving the second agent response;
processing, at the observability layer, the second agent response and the endpoint response generated by the endpoint in response to the agent request, to determine that the second agent response is accurate; and
in response to determining that the second agent response is accurate, passing, from the observability layer, the second agent response to the primary requester as responsive to the primary request.

2. The computer-implemented method of claim 1, wherein processing the agent response to determine that the agent response is inaccurate, further includes:
processing, at the observability layer, the agent response and the endpoint response to determine that the agent response includes a hallucination.

3. The computer-implemented method of claim 1, further comprising:
receiving, at the observability layer and from the AI agent, a second agent request to a second endpoint prior to the second endpoint receiving the second agent request;
passing, from the observability layer, the second agent request to the second endpoint;
receiving, at the observability layer and from the second endpoint, a second endpoint response prior to the AI agent receiving the second endpoint response;
determining, at the observability layer, that the second endpoint response is inaccurate; and
in response to determining that the second endpoint response is inaccurate:
constraining the second endpoint; and
sending, from the observability layer and to a third endpoint, the second agent request.

4. The computer-implemented method of claim 1, further comprising:
receiving, at the observability layer and from the AI agent, a second agent request to a second endpoint prior to the second endpoint receiving the second agent request;
passing, from the observability layer, the second agent request to the second endpoint;
receiving, at the observability layer and from the second endpoint, a second endpoint response prior to the AI agent receiving the second endpoint response;
determining, at the observability layer, that the second endpoint response is inaccurate; and
in response to determining that the second endpoint response is inaccurate:
constraining the second endpoint; and
returning, from the observability layer and to the AI agent, an error message indicating that the second endpoint is unavailable.

5. The computer-implemented method of claim 1, wherein processing the agent response and the endpoint response to determine that the agent response is inaccurate, further includes:
processing, at the observability layer, the agent response and the endpoint response generated by the endpoint in response to the agent request, to determine a hallucination probability score indicative of a probability that the agent response includes a hallucination;
determining that the hallucination probability score exceeds a threshold, and
in response to determining that the hallucination probability score exceeds the threshold, determining that the agent response is inaccurate.

6. A system, comprising:
a first verification component configured to, at least:
receive, from an artificial intelligence (“AI”) agent, an agent request to an endpoint prior to receipt of the agent request at the endpoint;
process the agent request to determine that the agent request is inaccurate;
in response to determination that the agent request is inaccurate:
refrain from passing the agent request to the endpoint; and
send a message to the AI agent that conforms to a schema of the endpoint such that the message appears to be sent to the AI agent by the endpoint; and
a second verification component configured to, at least:
receive from the endpoint, an endpoint response prior to receipt of the endpoint response by the AI agent, wherein the endpoint response is generated by the endpoint in response to a second agent request from the AI agent that is received at the endpoint;
process the endpoint response to determine that the endpoint response is accurate; and
pass the endpoint response to the AI agent.

7. The system of claim 6, further comprising:
a third verification component configured to, at least:
receive, from the AI agent, an agent response to a primary request prior to receipt of the agent response by a primary requester;
process the agent response to determine that the agent response is inaccurate; and
in response to determination that the agent response is inaccurate:
refrain from passing the agent response to the primary requester; and
send a second message to the AI agent that conforms to a second schema of the primary requester such that the second message appears to be sent to the AI agent by the primary requester.

8. The system of claim 6, further comprising:
a state tracker component configured to, at least:
maintain a state of requests and responses between a primary requester, the AI agent, and the endpoint.

9. The system of claim 8, wherein the state tracker component is further configured to, at least:
generate, based at least in part on the requests and responses between the primary requester, the AI agent, and the endpoint, a summary of a session.

10. The system of claim 6, wherein the first verification component is further configured to, at least:
receive, from the AI agent, the second agent request to the endpoint prior to receipt of the second agent request at the endpoint;
process the second agent request to produce a probability score indicative of a probability that the second agent request includes a hallucination;
determine that the probability score does not exceed a threshold; and
in response to determination that the probability score does not exceed the threshold, pass the second agent request to the endpoint.

11. The system of claim 6, wherein the first verification component configured to process the agent request to determine that the agent request is inaccurate, further includes:
process the agent request to determine that the agent request is a repetitive request.

12. The system of claim 6, wherein the first verification component configured to process the agent request to determine that the agent request is inaccurate, further includes:
process the agent request to determine that the agent request does not conform to the schema of the endpoint.

13. The system of claim 6, wherein the first verification component configured to process the agent request to determine that the agent request is inaccurate, further includes:
process the agent request to determine that the agent request does not follow a defined protocol for the endpoint.

14. The system of claim 6, wherein the first verification component configured to process the agent request to determine that the agent request is inaccurate, further includes:
provide, as input to a neural network, the agent request;
receive, as output from the neural network, a hallucination probability score indicative of a probability that the agent request includes a hallucination; and
determine that the hallucination probability score exceeds a threshold.

15. The system of claim 6, wherein the second verification component is further configured to, at least:
receive, from a second endpoint, a second endpoint response prior to receipt of the second endpoint response by the AI agent, wherein the second endpoint response is generated by the second endpoint in response to a third agent request from the AI agent that is received at the second endpoint;
process the second endpoint response to determine that the second endpoint response is not responsive to the third agent request; and
in response to determination that the second endpoint response is not responsive to the third agent request:
constrain the second endpoint; and
send a second message to the AI agent indicating that the second endpoint is unavailable.

16. A computer-implemented method, comprising:
receiving, at an observability layer and from an artificial intelligence (“AI”) agent, an agent request to an endpoint prior to the endpoint receiving the agent request;
processing, with the observability layer, the agent request to determine that the agent request corresponds to a primary request received by the AI agent;
in response to determining that the agent request corresponds to the primary request, passing, from the observability layer, the agent request to the endpoint;
receiving, at the observability layer and from the endpoint, an endpoint response;
processing, with the observability layer, the endpoint response to determine that the endpoint response is not received within a predetermined time or is inaccurate; and
in response to the determining by the observability layer:
constraining the endpoint; and
sending a message to the AI agent that conforms to a schema of the endpoint such that the message appears to be sent to the AI agent by the endpoint, the message indicating that the endpoint is unavailable.

17. The computer-implemented method of claim 16, further comprising:
subsequent sending the message to the AI agent, receiving at the observability layer and from the AI agent, a second agent request to a second endpoint prior to the second endpoint receiving the second agent request;
processing, with the observability layer, the second agent request to determine that the second agent request corresponds to the primary request received by the AI agent;
in response to determining that the second agent request corresponds to the primary request, passing the second agent request to the second endpoint;
receiving, at the observability layer and from the second endpoint, a second endpoint response;
processing, with the observability layer, the second endpoint response to determine that the second endpoint response is accurate; and
in response to determining that the second endpoint response is accurate, passing the second endpoint response to the AI agent.

18. The computer-implemented method of claim 16, wherein constraining the endpoint includes at least one of: removing the endpoint from an availability list, isolating the endpoint, suspending the endpoint, restarting the endpoint, or terminating the endpoint.

19. The computer-implemented method of claim 16, further comprising:
receiving, at the observability layer, a second endpoint response that is responsive to a second agent request sent by the AI agent; and
passing, with the observability layer and to the AI agent, the second endpoint response.

20. The computer-implemented method of claim 16, further comprising:
receiving, at the observability layer and from the AI agent, a second agent request to a second endpoint prior to the second endpoint receiving the second agent request;
passing, from the observability layer, the second agent request to the second endpoint;
receiving, at the observability layer and from the second endpoint, a second endpoint response prior to the AI agent receiving the second endpoint response;
determining, at the observability layer, that the second endpoint response is inaccurate; and
in response to determining that the second endpoint response is inaccurate:
constraining the second endpoint; and
sending, from the observability layer and to a third endpoint, the second agent request.
